(19) United States
(12) Patent Application Publication
(10) Pub. No.: US 2024/0329554 A1
(43) Pub. Date: Oct. 3, 2024

(54) TONER SET, ELECTROSTATIC IMAGE DEVELOPER SET, TONER CARTRIDGE SET, PROCESS CARTRIDGE, IMAGE FORMING APPARATUS, IMAGE FORMING METHOD, AND PRINTED MATERIAL

(71) Applicant: FUJIFILM Business Innovation Corp., Tokyo (JP)

(72) Inventors: Yukiaki NAKAMURA, Kanagawa (JP); Takahisa TATEKAWA, Kanagawa (JP); Kohei MANABE, Kanagawa (JP)

(73) Assignee: FUJIFILM Business Innovation Corp., Tokyo (JP)

(21) Appl. No.: 18/588,260

(22) Filed: Feb. 27, 2024

(30) Foreign Application Priority Data
Mar. 29, 2023 (JP) 2023-054184

(51) Int. Cl. G03G 9/09; G03G 15/01

(52) U.S. Cl. CPC G03G 9/0926; G03G 15/0184; G03G 2215/066

(57) ABSTRACT

A toner set includes cyan, magenta, yellow, and black toners, a fluorescent toner T_{A} having a hue angle of 125 degrees or more and 165 degrees or less, and a fluorescent toner T_{B} having a hue angle of −25 degrees or more and 15 degrees or less, wherein a difference between the hue angles of the fluorescent toners T_{A} and T_{B} is 135 degrees or more.

### CROSS-REFERENCE TO RELATED APPLICATIONS

This application is based on and claims priority under 35 USC 119 from Japanese Patent Application No. 2023-054184 filed Mar. 29, 2023.

### BACKGROUND

### (i) Technical Field

The present disclosure relates to a toner set, an electrostatic image developer set, a toner cartridge set, a process cartridge, an image forming apparatus, an image forming method, and a printed material.

### (ii) Related Art

Japanese Unexamined Patent Application Publication No. 2021-127427 discloses a resin particles set that includes fluorescent resin particles including a fluorescent coloring agent and colored resin particles including a colored coloring agent, wherein the fluorescent resin particles have a larger volume average size than the colored resin particles and the fluorescent resin particles have an average circularity of 0.93 or more. It is also disclosed that the fluorescent resin particles and the colored resin particles can be used as an electrostatic image developing toner.

### SUMMARY

Aspects of non-limiting embodiments of the present disclosure relate to a toner set with which images excellent in terms of graininess and gray tone may be formed, compared with the case where the toner set includes a cyan toner, a magenta toner, a yellow toner, a black toner, a fluorescent toner T_{A} having a hue angle of 125 degrees or more and 165 degrees or less, and a fluorescent toner T_{B} having a hue angle of −25 degrees or more and 15 degrees or less and the difference between the hue angles of the fluorescent toners T_{A} and T_{B} is less than 135 degrees.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a toner set including a cyan toner, a magenta toner, a yellow toner, a black toner, a fluorescent toner T_{A} having a hue angle of 125 degrees or more and 165 degrees or less, and a fluorescent toner T_{B} having a hue angle of −25 degrees or more and 15 degrees or less, wherein a difference between the hue angles of the fluorescent toners T_{A} and T_{B} is 135 degrees or more.

### BRIEF DESCRIPTION OF THE DRAWINGS

Exemplary embodiments of the present disclosure will be described in detail based on the following figures, wherein:

FIG. 1 is a schematic diagram illustrating an example of an image forming apparatus according to an exemplary embodiment of the disclosure; and

FIG. 2 is a schematic diagram illustrating an example of a process cartridge detachably attachable to the image forming apparatus according to an exemplary embodiment of the disclosure.

### DETAILED DESCRIPTION

Exemplary embodiments of the present disclosure are described below. It should be noted that the following description and Examples are illustrative of the exemplary embodiments but not restrictive of the scope of the exemplary embodiments.

In the present disclosure, a numerical range expressed using “to” means the range that includes the values described before and after “to” as the minimum and maximum values, respectively.

In the present disclosure, when numerical ranges are described in a stepwise manner, the upper or lower limit of a numerical range may be replaced with the upper or lower limit of another numerical range, respectively. In the present disclosure, the upper or lower limit of a numerical range may also be replaced with a value described in Examples below.

In the present disclosure, the term “step” refers not only to an individual step but also to a step that is not distinguishable from other steps but achieves the intended purpose of the step.

In the present disclosure, when an exemplary embodiment is described with reference to a drawing, the structure of the exemplary embodiment is not limited to the structure illustrated in the drawing. The sizes of the members illustrated in the attached drawing are conceptual and do not limit the relative relationship among the sizes of the members.

Each of the components described in the present disclosure may include a plurality of types of substances that correspond to the component. In the present disclosure, in the case where a composition includes a plurality of substances that correspond to a component of the composition, the content of the component in the composition is the total content of the substances in the composition unless otherwise specified.

Each of the components described in the present disclosure may include a plurality of types of particles that correspond to the component. In the case where a composition includes a plurality of particles that correspond to a component of the composition, the size of particles of the component is the size of particles of a mixture of the plurality of particles included in the composition unless otherwise specified.

In the present disclosure, the term “(meth) acryl” refers to both “acryl” and “methacryl”, and the term “(meth) acrylate” refers to both “acrylate” and “methacrylate”.

In the present disclosure, “electrostatic image developer” and “electrostatic image developing carrier” are also referred to as “developer” and “carrier”, respectively.

### Toner Set

A toner set according to an exemplary embodiment of the disclosure is a toner set including a cyan toner, a magenta toner, a yellow toner, a black toner, a fluorescent toner T_{A} having a hue angle of 125 degrees or more and 165 degrees or less, and a fluorescent toner T_{B} having a hue angle of −25 degrees or more and 15 degrees or less, wherein a difference between the hue angles of the fluorescent toners T_{A} and T_{B} is 135 degrees or more.

It has become popular to view photographs, pictures, illustrations, and the like with a vivid monitor due to the evolution and widespread use of televisions, monitors, tablets, smartphones, and the like. In photographs, illustrations (e.g., illustrations drawn with a PC), and the like viewed with a monitor, smooth rendering in light colors, such as gradation, is achieved in addition to a wide color gamut.

In electrophotographic printing, process printing in which cyan (C), magenta (M), yellow (Y), and black (K) are used is commonly employed. In process printing, where the density of a color is expressed using dot density, a light-colored portion is recognized as sparse dots and may appear as a roughness. The roughness may be also referred as “graininess”.

A known approach to forming a light-colored image that does not appear grainy, that is, a light-colored image excellent in terms of graininess, is to use light-color toners, such as a light cyan toner, a light magenta toner, and a gray toner. However, it is not possible to widen color gamut by only using the light-color toners.

There has been also proposed a multicolor toner set that includes, for example, green, orange, and violet toners in order to widen color gamut. However, in such a case, the graininess of a highlighted portion of an achromatic region (i.e., gray tone portion), such as a monochrome photograph, cannot be improved.

The toner set according to an exemplary embodiment of the disclosure includes, in addition to cyan, magenta, yellow, and black toners, a fluorescent toner T_{A} having a hue angle of 125 degrees or more and 165 degrees or less and a fluorescent toner T_{B} having a hue angle of −25 degrees or more and 15 degrees or less. Furthermore, the difference between the hue angles of the fluorescent toners T_{A} and T_{B} is 135 degrees or more.

Using the above six toners enables the formation of an image having a wide color gamut and an image excellent in terms of graininess. This is presumably because, since the fluorescent toners T_{A} and T_{B} fluoresce upon receiving light, in the simulation of a light color that contains sparse dots, the boundary of the dots become blurred as a result of large optical dot gain.

Furthermore, since the fluorescent toners T_{A} and T_{B} are complementary colors (i.e., opposite colors), a light gray tone, which is an achromatic region, may also be simulated using a toner set including these toners.

For the above reasons, images excellent in terms of graininess and gray tone may be formed using the toner set according to an exemplary embodiment of the disclosure.

### Preferable Aspects

In the toner set according to an exemplary embodiment of the disclosure, the difference between the hue angles of the fluorescent toners T_{A} and T_{B} is preferably 145 degrees or more and 180 degrees or less and is more preferably 160 degrees or more and 180 degrees or less in order to form images further excellent in terms of gray tone.

In the toner set according to an exemplary embodiment of the disclosure, the difference in the degrees of chroma of the fluorescent toners T_{A} and T_{B} is preferably 30 or less, is more preferably 25 or less, and is further preferably 20 or less in order to form images further excellent in terms of gray tone.

The difference in the degrees of chroma of the fluorescent toners T_{A} and T_{B} may be 0 and may be 10 or more.

In the toner set according to an exemplary embodiment of the disclosure, the difference in the degrees of lightness of the fluorescent toners T_{A} and T_{B} is preferably 20 or less, is more preferably 15 or less, and is further preferably 10 or less in order to form images further excellent in terms of gray tone.

The difference in the degrees of lightness of the fluorescent toners T_{A} and T_{B} may be 0 and may be 3 or more.

In the toner set according to an exemplary embodiment of the disclosure, it is preferable that the difference in the degrees of chroma of the fluorescent toners T_{A} and T_{B} be 30 or less and the difference in the degrees of lightness of the fluorescent toners T_{A} and T_{B} be 20 or less, it is more preferable that the difference in the degrees of chroma of the fluorescent toners T_{A} and T_{B} be 25 or less and the difference in the degrees of lightness of the fluorescent toners T_{A} and T_{B} be 15 or less, and it is further preferable that the difference in the degrees of chroma of the fluorescent toners T_{A} and T_{B} be 20 or less and the difference in the degrees of lightness of the fluorescent toners T_{A} and T_{B} be 10 or less, in order to form images still further excellent in terms of gray tone.

In the toner set according to an exemplary embodiment of the disclosure, it is preferable that the difference between the hue angles of the fluorescent toners T_{A} and T_{B} be 145 degrees or more and 180 degrees or less, the difference in the degrees of chroma of the fluorescent toners T_{A} and T_{B} be 30 or less, and the difference in the degrees of lightness of the fluorescent toners T_{A} and T_{B} be 20 or less.

The hue angle, chroma, and lightness of a toner are determined by the following method.

The toner that is to be analyzed is charged into “Revoria Press PC1120” produced by FUJIFILM Business Innovation Corp. A solid image (4.0 cm×2.5 cm) is formed on an A4-size sheet of “OS Coat Paper” (127 gsm) used as a recording medium at a toner deposition density of 4.0 g/m2 and a fusing temperature of 180° C. using the above apparatus with only the toner that is to be analyzed.

For determining hue angle (h), chroma (C*), and lightness (L*), the solid image formed on the recording medium by the above-described method is subjected to “eXact Advanced” (aperture 4 mm) produced by X-Rite, Inc. 10 times randomly. The average color gamut of the solid image is used as color reproduction values (L*,a*, and b*). Lightness (L*) is calculated from the color reproduction values (L*,a*, and b*). Hue angle (h) and chroma (C*) are calculated using the following formulae.

$${{{Chroma ( C * ) = ( ( a * )}^{2} + ( b * )}^{2} ) )}^{1 / 2}$$

$$Hue angle ( h ) = {tan}^{- 1} ( b * / a * )$$

In the toner set according to an exemplary embodiment of the disclosure, the fluorescence intensities of the fluorescent toners T_{A} and T_{B} are preferably 5% or more, are more preferably 10% or more, and are further preferably 15% or more in order to form images further excellent in terms of graininess.

The upper limit for the fluorescence intensities of the fluorescent toners T_{A} and T_{B} is not limited and is, for example, 50% or less.

The fluorescence intensity of a toner is determined by the following method.

A solid image (4.0 cm×2.5 cm) is formed on a recording medium with only the toner that is to be analyzed, by the same method as that used for determining the hue angle, chroma, and lightness of a toner.

The spectral reflectance of the solid image is measured with “exact Advanced” (aperture: 4 mm) produced by X-Rite, Inc. under each of the lighting conditions M1 and M2 defined in ISO 13655. The spectral reflectance X1 (%) at the peak top of the spectral reflectance spectrum measured under the lighting conditions M1 and the spectral reflectance X2 (%) at the peak top of the spectral reflectance spectrum measured under the lighting conditions M2 are determined. The difference therebetween (M1-M2) is used as a fluorescence intensity.

Details of the toners included in the toner set according to an exemplary embodiment of the disclosure are described below.

### Toner Set

The toner set according to an exemplary embodiment of the disclosure includes cyan, magenta, yellow, and black toners and fluorescent toners T_{A} and T_{B}.

The toner set according to an exemplary embodiment of the disclosure may include a toner other than any of the above six toners (hereinafter, such a toner is also referred to as “the other toner”).

The other toner may be a fluorescent or nonfluorescent toner.

Examples of the fluorescent toner include fluorescent red, orange, yellow, and purple toners.

Examples of the nonfluorescent toner include red, green, blue, orange, and violet toners. Cyan, Magenta, Yellow, and Black Toners

The cyan, magenta, yellow, and black toners included in the toner set according to an exemplary embodiment of the disclosure are all nonfluorescent toners each including a nonfluorescent coloring agent.

The cyan, magenta, yellow, and black toners known in the related art may be used as cyan, magenta, yellow, and black toners, respectively.

### Fluorescent Toner T_{A} (Fluorescent Green Toner)

The fluorescent toner T_{A} may be any fluorescent toner having a hue angle of 125 degrees or more and 165 degrees or less.

The fluorescent toner T_{A} may be also referred to as “fluorescent green toner” since the hue angle of the fluorescent toner T_{A} falls within the above range.

The hue angle of the fluorescent toner T_{A} is preferably 130 degrees or more and 160 degrees or less and is more preferably 135 degrees or more and 155 degrees or less.

### Fluorescent Toner T_{B} (Fluorescent Pink Toner)

The fluorescent toner T_{B} may be any fluorescent toner having a hue angle of −25 degrees or more and 15 degrees or less.

The fluorescent toner T_{B} may be also referred to as “fluorescent pink toner” since the hue angle of the fluorescent toner T_{B} falls within the above range.

The hue angle of the fluorescent toner T_{B} is preferably −25 degrees or more and 5 degrees or less and is more preferably −25 degrees or more and 0 degree or less.

### Toner Particles

The fluorescent toners T_{A} and T_{B} each include toner particles that include a fluorescent coloring agent and a binder resin and may include a release agent and other additives as needed.

Each of the components of the toner particles is described below.

### Coloring Agent Included in Fluorescent Toner T_{A}

The coloring agent included in the toner particles of the fluorescent toner T_{A} includes at least a fluorescent coloring agent.

The toner particles of the fluorescent toner T_{A} preferably include a fluorescent pigment having a hydrophilic group, which serves as a fluorescent coloring agent, in order to achieve the hue angle that falls within the above range and in consideration of lightness, chroma, and the like.

The toner particles of the fluorescent toner T_{A} preferably include a nonfluorescent coloring agent that serves as a coloring agent, in addition to the fluorescent coloring agent, in order to achieve the hue angle that falls within the above range.

In consideration of lightness, chroma, and the like, the toner particles preferably include a pigment having a halogen atom which serves as a nonfluorescent coloring agent.

Note that the term “fluorescent coloring agent” used herein refers to a coloring agent (e.g., dye or pigment) that fluoresces upon receiving light energy from the outside, while the term “nonfluorescent coloring agent” used herein refers to a coloring agent that does not fluoresce upon receiving light energy from the outside. In general, a fluorescent coloring agent exhibits a color due to the reflection and emission of light, while a nonfluorescent coloring agent exhibits a color due to only the reflection of light.

### Fluorescent Pigment Having Hydrophilic Group

The fluorescent pigment having a hydrophilic group is preferably a yellow fluorescent pigment in consideration of lightness and chroma.

The fluorescent pigment having a hydrophilic group preferably has an emission peak at wavelengths of 500 nm or more and 550 nm or less in the emission spectrum in consideration of lightness and chroma.

Examples of the hydrophilic group included in the fluorescent pigment having a hydrophilic group include a hydroxyl group, primary to tertiary amino groups, a carboxyl group, a sulfo group, and a phosphate group.

Among these, the fluorescent pigment having a hydrophilic group preferably includes a hydroxyl group as a hydrophilic group.

Examples of the fluorescent pigment having a hydrophilic group include an azomethine compound, an isoindolinone compound, a xanthene compound (e.g., a rhodamine compound, a fluorescein compound, and an eosine compound), a naphthalene compound, and a triarylmethane compound, which have a hydrophilic group.

Among these, the fluorescent pigment having a hydrophilic group is preferably an azomethine compound and is more preferably a bisazomethine compound in order to reduce variations in the gloss of the resulting image.

Examples of the azomethine compound include a compound having an azomethine structure represented by —R¹C═N—, where R¹ represents a hydrogen atom or a monovalent substituent.

Examples of the bisazomethine compound include a compound having a bisazomethine structure represented by —R¹C═N—N═CR²— in the molecular structure, where R¹ and R² each independently represent a hydrogen atom or a monovalent substituent.

Examples of the fluorescent pigment having a hydrophilic group include the azomethine compounds (1) to (3) below.

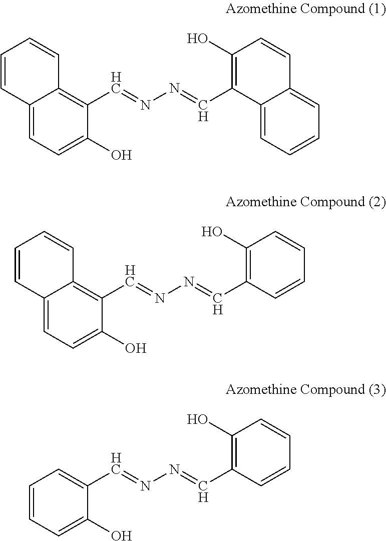 [SMILES: Oc1ccc2ccccc2c1/C=N/N=C/c1c(O)ccc2ccccc12 ; Oc1ccccc1/C=N/N=C/c1c(O)ccc2ccccc12 ; Oc1ccccc1/C=N/N=C/c1ccccc1O]

The emission peak wavelength of the azomethine compound (1) is 520 nm.

The emission peak wavelength of the azomethine compound (2) is 510 nm.

The emission peak wavelength of the azomethine compound (3) is 520 nm.

The fluorescent pigment having a hydrophilic group is preferably at least one selected from the group consisting of the azomethine compounds (1), (2), and (3).

The fluorescent pigment having a hydrophilic group is preferably C.I. Pigment Yellow 101. Note that C.I. Pigment Yellow 101 is the azomethine compound (1).

The proportion of the amount of the hydroxyl group included per molecule of the fluorescent pigment having a hydrophilic group to the molecular weight of the fluorescent pigment having a hydrophilic group is preferably 20% by mass or less, is more preferably 12% by mass or less, is further preferably more than 0% by mass and 12% by mass or less, and is particularly preferably 5% by mass or more and 12% by mass or less in order to reduce variations in the gloss of the resulting image.

The volume average particle size D1 of the fluorescent pigment having a hydrophilic group is preferably 50 nm or more and 800 nm or less, is more preferably 150 nm or more and 600 nm or less, and is further preferably 250 nm or more and 400 nm or less in order to enhance dispersibility in toner particles, color formability on recording media, fixability to recording media, and the like in a balanced manner.

The volume average particle size of a pigment is determined by dispersing the pigment in an aqueous solution containing a surfactant and analyzing the resulting dispersion liquid with a laser diffraction particle size distribution analyzer (e.g., “LA-700” produced by HORIBA, Ltd.). In ascending order in terms of particle size, the cumulative volume is calculated and plotted to draw a volume-basis particle size distribution curve. A particle diameter at which the cumulative volume reaches 50% is considered as a volume average particle size.

The number of types of the fluorescent pigments having a hydrophilic group may be only one or two or more and is preferably only one in consideration of the lightness and chroma of the resulting images.

The content of the fluorescent pigment having a hydrophilic group is preferably 0.1% by mass or more and 30% by mass or less, is more preferably 0.5% by mass or more and 25% by mass or less, is further preferably 1% by mass or more and 20% by mass or less, and is particularly preferably 5% by mass or more and 15% by mass or less of the total amount of the toner particles in consideration of lightness and chroma.

The content of the fluorescent pigment having a hydrophilic group is preferably larger than that of the pigment having a halogen atom, which is described below.

### Pigment Having Halogen Atom

The pigment having a halogen atom is preferably a nonfluorescent pigment and is more preferably a nonfluorescent green pigment in consideration of lightness and chroma.

The pigment having a halogen atom preferably has a reflection peak at wavelengths of 480 nm or more and 540 nm or less in the reflection spectrum in consideration of lightness and chroma.

Examples of the halogen atom included in the pigment having a halogen atom include a fluorine atom, a chlorine atom, a bromine atom, and an iodine atom.

In particular, the pigment having a halogen atom preferably has at least one halogen atom selected from the group consisting of chlorine and bromine atoms and more preferably has both chlorine and bromine atoms.

The pigment having a halogen atom preferably has 2 or more halogen atoms, more preferably has 4 or more halogen atoms, further preferably has 6 or more halogen atoms, and particularly preferably has 8 to 32 halogen atoms.

Examples of the pigment having a halogen atom include a halogenated phthalocyanine compound and a lake pigment of a halogenated triphenylmethane dye.

The pigment having a halogen atom is preferably a halogenated phthalocyanine compound and is more preferably at least one selected from the group consisting of halogenated copper phthalocyanine and halogenated zinc phthalocyanine.

Examples of the halogenated copper phthalocyanine include C. I. Pigment Green 7 (hue: bluish green, having 15 chlorine atoms), C. I. Pigment Green 36 (hue: yellowish green, having 10 chlorine atoms and 6 bromine atoms), and C. I. Pigment Blue 76 (hue: blue, having 8 to 12 chlorine atoms).

Examples of the halogenated zinc phthalocyanine include C. I. Pigment Green 58 (hue: green, having 3 chlorine atoms and 13 bromine atoms) and C. I. Pigment Green 59 (hue: green, having 0 to 16 chlorine atoms and 0 to 16 bromine atoms).

The pigment having a halogen atom is preferably at least one selected from the group consisting of C. I. Pigment Green 7, C. I. Pigment Green 36, C. I. Pigment Green 58, C. I. Pigment Green 59, and C. I. Pigment Blue 76.

The volume average particle size D2 of the pigment having a halogen atom is preferably 50 nm or more and 300 nm or less, is more preferably 100 nm or more and 250 nm or less, and is further preferably 120 nm or more and 200 nm or less in order to enhance dispersibility in toner particles, color formability on recording media, fixability to recording media, and the like in a balanced manner.

The number of types of the pigments having a halogen atom may be only one or two or more.

The content of the pigment having a halogen atom is preferably 0.1% by mass or more and 30% by mass or less, is more preferably 0.2% by mass or more and 20% by mass or less, is further preferably 0.5% by mass or more and 20% by mass or less, and is particularly preferably 1% by mass or more and 15% by mass or less of the total amount of the toner particles in consideration of lightness and chroma.

The content of the fluorescent pigment having a hydrophilic group is preferably larger than that of the pigment having a halogen atom.

The ratio of the volume average particle size D1 of the fluorescent pigment having a hydrophilic group to the volume average particle size D2 of the pigment having a halogen atom, that is, the ratio D1/D2, is preferably 1 or more and 3 or less, is more preferably 1.2 or more and 2.5 or less, and is further preferably 1.5 or more and 2 or less in or der to enhance the lightness and chroma of the resulting images.

The mass ratio of the content M2 of the pigment having a halogen atom in the toner particles to the content M1 of the fluorescent pigment having a hydrophilic group in the toner particles, that is, the ratio M2/M1, is preferably 0.05 or more and 1.5 or less in order to enhance the lightness and chroma of the resulting images.

The ratio M2/M1 is 0.05 or more, is preferably 0.1 or more, and is more preferably 0.3 or more in order to enhance the chroma of the resulting images.

The ratio M2/M1 is 1.5 or less, is preferably 1.0 or less, is more preferably less than 1.0, and is further preferably 0.8 or less in order to enhance the lightness of the resulting images.

The total content of the fluorescent pigment having a hydrophilic group and the pigment having a halogen atom in the toner particles is preferably 5% by mass or more and 20% by mass or less of the total amount of the toner particles.

The total content of the above two pigments is 5% by mass or more, is preferably 8% by mass or more, and is more preferably 10% by mass or more in order to enhance the chroma of the resulting images.

The total content of the above two pigments is preferably 18% by mass or less and is more preferably 15% by mass or less in order to enhance the lightness of the resulting images.

The difference in wavelength between the emission peak of one of the fluorescent pigments having a hydrophilic group which has the largest content among the fluorescent pigments included in the toner particles and the reflection peak of one of the pigments having a halogen atom which has the largest content among the pigments included in the toner particles is preferably 40 nm or less, is more preferably 30 nm or less, is further preferably 20 nm or less, is particularly preferably 10 nm or less, and is most preferably 0 nm in consideration of the lightness and chroma of the resulting images.

The toner particles may include a coloring agent other than the fluorescent pigment having a hydrophilic group or the pigment having a halogen atom.

The proportion of the total amount of the fluorescent pigment having a hydrophilic group and the pigment having a halogen atom to the total amount of the coloring agents included in the toner particles is preferably 90% by mass or more, is more preferably 95% by mass or more, and is further preferably 100% by mass.

### Coloring Agent Included in Fluorescent Toner T_{B}

The coloring agent included in the toner particles of the fluorescent toner T_{B} includes at least a fluorescent coloring agent.

The toner particles of the fluorescent toner T_{B} preferably include a compound (e.g., fluorescent dye or pigment) having a xanthene structure which serves as a fluorescent coloring agent, in order to, for example, achieve the hue angle that falls within the above range.

The toner particles of the fluorescent toner T_{B} preferably include a nonfluorescent coloring agent that serves as a coloring agent in addition to the fluorescent coloring agent, in order to achieve the hue angle that falls within the above range.

The nonfluorescent coloring agent preferably includes a compound (e.g., nonfluorescent pigment) having a quinacridone structure in order to, for example, achieve the hue angle that falls within the above range.

### Compound Having Xanthene Structure

The compound having a xanthene structure is preferably a compound having a rhodamine structure, a fluorescein structure, or an eosine structure and is more preferably a compound having a rhodamine structure in consideration of fluorescence intensity.

Examples of the compound having a xanthene structure include C. I. Basic Red 1 (Rhodamine 6GCP), C. I. Basic Red 1:1 (Rhodamine 6GCP-N), C. I. Basic Violet 10 (Rhodamine B), C. I. Basic Violet 11 (Rhodamine 3B), C. I. Basic Violet 11:1 (Rhodamine A), C. I. Acid Red 51, C. I. Acid Red 52, C. I. Acid Red 87, C. I. Acid Red 92, and Solvent Red 49.

The number of types of the compounds having a xanthene structure may be only one or two or more.

The content of the compound having a xanthene structure is preferably 0.01% by mass or more and 20% by mass or less, is more preferably 0.1% by mass or more and 3.5% by mass or less, and is further preferably 0.2% by mass or more and 2.0% by mass or less of the total mass of the toner particles.

### Compound Having Quinacridone Structure

Examples of the compound having a quinacridone structure include C. I. Pigment Red 122, C. I. Pigment Red 202, C. I. Pigment Red 207, C. I. Pigment Red 209, and C. I. Pigment Violet 19, in consideration of fluorescence intensity.

The compound having a quinacridone structure is preferably a magenta pigment and is particularly preferably C. I. Pigment Red 122.

The number of types of the compounds having a quinacridone structure may be only one or two or more.

The content of the compound having a quinacridone structure is preferably 0.005% by mass or more and 10% by mass or less, is more preferably 0.05% by mass or more and 1.5% by mass or less, and is further preferably 0.05% by mass or more and 1.2% by mass or less of the total mass of the toner particles.

### Binder Resin

Examples of the binder resin include vinyl resins that are homopolymers of the following monomers or copolymers of two or more monomers selected from the following monomers: styrenes, such as styrene, para-chlorostyrene, and α-methylstyrene; (meth) acrylates, such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate; ethylenically unsaturated nitriles, such as acrylonitrile and methacrylonitrile; vinyl ethers, such as vinyl methyl ether and vinyl isobutyl ether; vinyl ketones, such as vinyl methyl ketone, vinyl ethyl ketone, and vinyl isopropenyl ketone; and olefins, such as ethylene, propylene, and butadiene.

Examples of the binder resin further include non-vinyl resins, such as epoxy resins, polyester resins, polyurethane resins, polyamide resins, cellulose resins, polyether resins, and modified rosins; a mixture of the non-vinyl resin and the vinyl resin; and a graft polymer produced by polymerization of the vinyl monomer in the presence of the non-vinyl resin.

The above binder resins may be used alone or in combination of two or more.

A polyester resin may be suitably used as a binder resin.

Examples of the polyester resin include the polyester resins known in the related art.

Examples of the polyester resin include condensation polymers of a polyvalent carboxylic acid and a polyhydric alcohol. The polyester resin may be a commercially available one or a synthesized one.

Examples of the polyvalent carboxylic acid include aliphatic dicarboxylic acids, such as oxalic acid, malonic acid, maleic acid, fumaric acid, citraconic acid, itaconic acid, glutaconic acid, succinic acid, alkenyl succinic acid, adipic acid, and sebacic acid; alicyclic dicarboxylic acids, such as cyclohexanedicarboxylic acid; aromatic dicarboxylic acids, such as terephthalic acid, isophthalic acid, phthalic acid, and naphthalenedicarboxylic acid; anhydrides of these dicarboxylic acids; and lower (e.g., 1 to 5 carbon atoms) alkyl esters of these dicarboxylic acids. Among these polyvalent carboxylic acids, for example, aromatic dicarboxylic acids may be used.

Trivalent or higher carboxylic acids having a crosslinked structure or a branched structure may be used as a polyvalent carboxylic acid in combination with the dicarboxylic acids. Examples of the trivalent or higher carboxylic acids include trimellitic acid, pyromellitic acid, anhydrides of these carboxylic acids, and lower (e.g., 1 to 5 carbon atoms) alkyl esters of these carboxylic acids.

The above polyvalent carboxylic acids may be used alone or in combination of two or more.

Examples of the polyhydric alcohol include aliphatic diols, such as ethylene glycol, diethylene glycol, tricthylene glycol, propylene glycol, butanediol, hexanediol, and neopentyl glycol; alicyclic diols, such as cyclohexanediol, cyclohexanedimethanol, and hydrogenated bisphenol A; and aromatic diols, such as bisphenol A-ethylene oxide adduct and bisphenol A-propylene oxide adduct. Among these polyhydric alcohols, for example, aromatic diols and alicyclic diols may be used. In particular, aromatic diols may be used.

Trihydric or higher alcohols having a crosslinked structure or a branched structure may be used as a polyhydric alcohol in combination with the diols. Examples of the trihydric or higher alcohols include glycerin, trimethylolpropane, and pentacrythritol.

The above polyhydric alcohols may be used alone or in combination of two or more.

The glass transition temperature Tg of the polyester resin is preferably 50° C. or more and 80° C. or less and is more preferably 50° C. or more and 65° C. or less.

The glass transition temperature of the polyester resin is determined from a differential scanning calorimetry (DSC) curve obtained by DSC. More specifically, the glass transition temperature of the polyester resin is determined from the “extrapolated glass-transition-starting temperature” according to a method for determining glass transition temperature which is described in JIS K 7121:1987 “Testing Methods for Transition Temperatures of Plastics”.

The weight average molecular weight Mw of the polyester resin is preferably 5,000 or more and 1,000,000 or less and is more preferably 7,000 or more and 500,000 or less.

The number average molecular weight Mn of the polyester resin may be 2,000 or more and 100,000 or less.

The molecular weight distribution index Mw/Mn of the polyester resin is preferably 1.5 or more and 100 or less and is more preferably 2 or more and 60 or less.

The weight average molecular weight and number average molecular weight of the polyester resin are determined by gel permeation chromatography (GPC). Specifically, the molecular weights of the polyester resin are determined by GPC using a “HLC-8120GPC” produced by Tosoh Corporation as measuring equipment, a column “TSKgel SuperHM-M (15 cm)” produced by Tosoh Corporation, and a THF solvent. The weight average molecular weight and number average molecular weight of the polyester resin are determined on the basis of the results of the measurement using a molecular-weight calibration curve based on monodisperse polystyrene standard samples.

The polyester resin may be produced by any suitable production method known in the related art. Specifically, the polyester resin may be produced by, for example, a method in which polymerization is performed at 180° C. or more and 230° C. or less, the pressure inside the reaction system is reduced as needed, and water and alcohols that are generated by condensation are removed.

In the case where the raw materials, that is, the monomers, are not dissolved in or miscible with each other at the reaction temperature, a solvent having a high boiling point may be used as a dissolution adjuvant in order to dissolve the raw materials. In such a case, the condensation polymerization reaction is performed while the dissolution adjuvant is distilled away. In the case where a monomer having low miscibility is present, a condensation reaction of the monomers with an acid or alcohol that is to undergo a polycondensation reaction with the monomers may be performed in advance and subsequently polycondensation of the resulting polymers with the other components may be performed.

The content of the binder resin in the entire toner particles is preferably 40% by mass or more and 95% by mass or less, is more preferably 50% by mass or more and 90% by mass or less, and is further preferably 60% by mass or more and 85% by mass or less.

### Release Agent

Examples of the release agent include, but are not limited to, hydrocarbon waxes; natural waxes, such as a carnauba wax, a rice bran wax, and a candelilla wax; synthetic or mineral-petroleum-derived waxes, such as a montan wax; and ester waxes, such as a fatty-acid ester wax and a montanate wax.

The melting temperature of the release agent is preferably 50° C. or more and 110° C. or less and is more preferably 60° C. or more and 100° C. or less.

The above melting temperature is determined from the “melting peak temperature” according to a method for determining melting temperature which is described in JIS K 7121:1987 “Testing Methods for Transition Temperatures of Plastics” using a differential scanning calorimetry (DSC) curve obtained by DSC.

The content of the release agent is preferably 1% by mass or more and 20% by mass or less and is more preferably 5% by mass or more and 15% by mass or less of the total amount of the toner particles.

### Other Additives

Examples of the other additives include additives known in the related art, such as a magnetic substance, a charge-controlling agent, and an inorganic powder. These additives may be added to the toner particles as internal additives.

### Properties, Etc. of Toner Particles

The toner particles may have a single-layer structure or a “core-shell” structure constituted by a core (i.e., core particle) and a coating layer (i.e., shell layer) covering the core.

The core-shell structure of the toner particles may be constituted by, for example, a core including a binder resin and, as needed, other additives such as a coloring agent and a release agent and by a coating layer including a binder resin.

The volume average diameter D50v of the toner particles is preferably 2 μm or more and 10 μm or less and is more preferably 4 μm or more and 8 μm or less.

The various average particle sizes and various particle size distribution indices of the toner particles are measured using “COULTER MULTISIZER II” produced by Beckman Coulter, Inc. with an electrolyte “ISOTON-II” produced by Beckman Coulter, Inc. in the following manner.

A sample to be measured (0.5 mg or more and 50 mg or less) is added to 2 ml of a 5-mass % aqueous solution of a surfactant (e.g., sodium alkylbenzene sulfonate) that serves as a dispersant. The resulting mixture is added to 100 ml or more and 150 ml or less of an electrolyte.

The resulting electrolyte containing the sample suspended therein is subjected to a dispersion treatment for 1 minute using an ultrasonic disperser, and the distribution of the diameters of particles having a diameter of 2 μm or more and 60 μm or less is measured using COULTER MULTISIZER II with an aperture having a diameter of 100 μm. The number of the particles sampled is 50,000.

The particle diameter distribution measured is divided into a number of particle diameter ranges (i.e., channels). For each range, in ascending order in terms of particle diameter, the cumulative volume and the cumulative number are calculated and plotted to draw cumulative distribution curves. Particle diameters at which the cumulative volume and the cumulative number reach 16% are considered to be the volume particle diameter D16v and the number particle diameter D16p, respectively. Particle diameters at which the cumulative volume and the cumulative number reach 50% are considered to be the volume average particle diameter D50v and the number average particle diameter D50p, respectively. Particle diameters at which the cumulative volume and the cumulative number reach 84% are considered to be the volume particle diameter D84v and the number particle diameter D84p, respectively.

Using the volume particle diameters and number particle diameters measured, the volume particle size distribution index (GSDv) is calculated as (D84v/D16v)^{1/2} and the number particle size distribution index (GSDp) is calculated as (D84p/D16p)^{1/2}.

The toner particles preferably have an average circularity of 0.94 or more and 1.00 or less. The average circularity of the toner particles is more preferably 0.95 or more and 0.98 or less.

The average circularity of the toner particles is determined as [Equivalent circle perimeter]/[Perimeter] (i.e., [Perimeter of a circle having the same projection area as the particles]/[Perimeter of the projection image of the particles]. Specifically, the average circularity of the toner particles is determined by the following method.

The toner particles to be measured are sampled by suction so as to form a flat stream. A static image of the particles is taken by instantaneously flashing a strobe light. The image of the particles is analyzed with a flow particle image analyzer “FPIA-3000” produced by Sysmex Corporation. The number of samples used for determining the average circularity of the toner particles is 3,500.

In the case where the toner includes an external additive, the toner (i.e., the developer) to be measured is dispersed in water containing a surfactant and then subjected to an ultrasonic wave treatment in order to remove the external additive from the toner particles.

### External Additive

Examples of the external additive include inorganic particles. Examples of the inorganic particles include SiO₂ particles, TiO₂ particles, Al₂O₃ particles, CuO particles, ZnO particles, SnO₂ particles, CeO₂ particles, Fe₂O₃ particles, MgO particles, BaO particles, CaO particles, K₂O particles, Na₂O particles, ZrO₂ particles, CaO·SiO₂ particles, K₂O·(TiO₂) n particles, Al₂O₃·2SiO₂ particles, CaCO₃ particles, MgCO₃ particles, BaSO₄ particles, and MgSO₄ particles.

The surfaces of the inorganic particles used as an external additive may be subjected to a hydrophobic treatment. The hydrophobic treatment is performed by, for example, immersing the inorganic particles in a hydrophobizing agent. Examples of the hydrophobizing agent include, but are not limited to, a silane coupling agent, a silicone oil, a titanate coupling agent, and aluminum coupling agent. These hydrophobizing agents may be used alone or in combination of two or more.

The amount of the hydrophobizing agent is commonly, for example, 1 part by mass or more and 10 parts by mass or less relative to 100 parts by mass of the inorganic particles.

Examples of the external additive further include particles of a resin, such as polystyrene, polymethyl methacrylate, or a melamine resin; and particles of a cleaning lubricant, such as a metal salt of a higher fatty acid, such as zinc stearate, or a fluorine-contained resin.

The amount of the external additive used is preferably 0.01% by mass or more and 5% by mass or less and is more preferably 0.01% by mass or more and 2.0% by mass or less of the amount of the toner particles.

### Method for Producing Toner

The fluorescent toner constituting the toner set according to an exemplary embodiment of the disclosure is produced by, after the preparation of the toner particles, depositing an external additive on the surfaces of the toner particles.

The toner particles may be prepared by any dry process, such as knead pulverization, or any wet process, such as aggregation coalescence, suspension polymerization, or dissolution suspension. However, a method for preparing the toner particles is not limited thereto, and any suitable method known in the related art may be used. Among these methods, aggregation coalescence may be used in order to prepare the toner particles.

In the case where toner particles are produced by aggregation coalescence, the following production method may be used.

Specifically, a production method including:
a step of preparing a resin particle dispersion liquid in which particles of a resin that serves as a binder resin are dispersed (i.e., resin particle dispersion liquid preparation step);
a step of preparing a coloring agent dispersion liquid in which a coloring agent or colored particles are dispersed (i.e., coloring agent dispersion liquid preparation step);
a step of mixing the resin particle dispersion liquid with the coloring agent dispersion liquid and causing the mixed particles to aggregate together in the resulting mixed dispersion liquid to form aggregated particles (i.e., aggregated particle formation step); and
a step of heating the aggregated particle dispersion liquid in which the aggregated particles are dispersed in order to cause fusion and coalescence of the aggregated particles and form toner particles (i.e., fusion-coalescence step).

The above production method may further include a step of preparing a release agent particle dispersion liquid in which release agent particles are dispersed (i.e., release agent particle dispersion liquid preparation step) as needed.

Each of the above steps is described below in detail.

### Resin Particle Dispersion Liquid Preparation Step

The resin particle dispersion liquid is prepared by, for example, dispersing resin particles in a dispersion medium using a surfactant.

Examples of the dispersion medium used for preparing the resin particle dispersion liquid include aqueous media.

Examples of the aqueous media include water, such as distilled water and ion-exchange water; and alcohols. These aqueous media may be used alone or in combination of two or more.

Examples of the surfactant include anionic surfactants, such as sulfate surfactants, sulfonate surfactants, and phosphate surfactants; cationic surfactants, such as amine salt surfactants and quaternary ammonium salt surfactants; and nonionic surfactants, such as polyethylene glycol surfactants, alkylphenol ethylene oxide adduct surfactants, and polyhydric alcohol surfactants. Among these surfactants, in particular, the anionic surfactants and the cationic surfactants may be used. The nonionic surfactants may be used in combination with the anionic surfactants and the cationic surfactants.

These surfactants may be used alone or in combination of two or more.

In the preparation of the resin particle dispersion liquid, the resin particles can be dispersed in a dispersion medium by any suitable dispersion method commonly used in the related art in which, for example, a rotary-shearing homogenizer, a ball mill, a sand mill, or a dyno mill that includes media is used. Depending on the type of the resin particles used, the resin particles may be dispersed in the dispersion medium by phase-inversion emulsification. Phase-inversion emulsification is a method in which the resin to be dispersed is dissolved in a hydrophobic organic solvent in which the resin is soluble, a base is added to the resulting organic continuous phase (i.e., O phase) to perform neutralization, and subsequently an aqueous medium (i.e., W phase) is charged in order to perform phase inversion from W/O to O/W and disperse the resin in the aqueous medium in the form of particles.

The volume average size of the resin particles dispersed in the resin particle dispersion liquid is preferably, for example, 0.01 μm or more and 1 μm or less, is more preferably 0.08 μm or more and 0.8 μm or less, and is further preferably 0.1 μm or more and 0.6 μm or less. The volume average size of the resin particles is determined in the following manner. The particle diameter distribution of the resin particles is obtained using a laser-diffraction particle-size-distribution measurement apparatus, such as “LA-700” produced by HORIBA, Ltd. The particle diameter distribution measured is divided into a number of particle diameter ranges (i.e., channels). For each range, in ascending order in terms of particle diameter, the cumulative volume is calculated and plotted to draw a cumulative distribution curve. A particle diameter at which the cumulative volume reaches 50% is considered to be the volume particle diameter D50v. The volume average sizes of particles included in the other dispersion liquids are also determined in the above-described manner.

The content of the resin particles included in the resin particle dispersion liquid is preferably 5% by mass or more and 50% by mass or less and is more preferably 10% by mass or more and 40% by mass or less.

### Release Agent Particle Dispersion Liquid Preparation Step

The method for preparing the release agent particle dispersion liquid is the same as the method for preparing the resin particle dispersion liquid.

The content of the release agent particles in the release agent particle dispersion liquid is preferably 5% by mass or more and 50% by mass or less and is more preferably 10% by mass or more and 40% by mass or less.

### Coloring Agent Dispersion Liquid Preparation Step

In the case where the coloring agent is a pigment (e.g., fluorescent or nonfluorescent pigment), the coloring agent dispersion liquid is prepared by, for example, dispersing the pigment (i.e., the coloring agent) in a dispersion medium with a surfactant.

In the case where the coloring agent is a dye (e.g., fluorescent or nonfluorescent dye), the coloring agent dispersion liquid is prepared by, for example, dispersing particles colored with the dye in a dispersion medium with a surfactant.

The colored particles include a resin as well as a dye and can be prepared by, for example, mixing the dye with the resin while performing heating and pulverizing the resulting mixture.

For pulverizing the mixture, pulverizers known in the related art, such as a Banbury mixer or a jet mill, may be used. A plurality of pulverizers may be used in combination.

Examples of the dispersion medium used for the coloring agent dispersion liquid include an aqueous medium.

Examples of the aqueous medium include water, such as distilled water or ion-exchange water, and an alcohol. The above aqueous media may be used alone or in combination of two or more.

Examples of the surfactant include anionic surfactants, such as sulfate surfactants, sulfonate surfactants, and phosphate surfactants; cationic surfactants, such as amine salt surfactants and quaternary ammonium salt surfactants; and nonionic surfactants, such as polyethylene glycol surfactants, alkylphenol ethylene oxide adduct surfactants, and polyhydric alcohol surfactants. Among these surfactants, the anionic and cationic surfactants may be used. The nonionic surfactants may be used in combination with the anionic surfactants and the cationic surfactants.

These surfactants may be used alone or in combination of two or more.

Examples of the method for dispersing the coloring agent or colored particles in the dispersion medium include a dispersion method in which a rotary-shearing homogenizer, a ball mill, a sand mill, a dyno mill, or Key Mill that includes media, or the like is used.

The volume average particle size of the coloring agent or colored particles dispersed in the coloring agent dispersion liquid is preferably, for example, 50 nm or more and 800 nm or less, is more preferably 150 nm or more and 600 nm or less, and is further preferably 250 nm or more and 400 nm or less. The size of the particles of coloring agent or colored particles can be adjusted by changing, for example, the method of the dispersion treatment and the amount of time during which the dispersion treatment is performed.

The content of the coloring agent or colored particles included in the coloring agent dispersion liquid is preferably 5% by mass or more and 50% by mass or less and is more preferably 10% by mass or more and 40% by mass or less.

### Aggregated Particle Formation Step

The resin particle dispersion liquid is mixed with the aggregation-induced emission colorant dispersion liquid and, as needed, the nonfluorescent organic pigment dispersion liquid and the release agent particle dispersion liquid. In the resulting mixed dispersion liquid, heteroaggregation of the resin particles, the aggregation-induced emission colorant, and, as needed, the nonfluorescent pigment and the release agent particles is performed to form aggregated particles that have a diameter close to that of the intended toner particles.

Specifically, for example, a coagulant is added to the mixed dispersion liquid, and the pH of the mixed dispersion liquid is controlled to be acidic (e.g., pH of 2 or more and 5 or less). A dispersion stabilizer may be added to the mixed dispersion liquid as needed. Subsequently, the mixed dispersion liquid is heated to a temperature close to the glass transition temperature of the resin particles (specifically, e.g., [Glass transition temperature of the resin particles −30° C.] or more and [the Glass transition temperature −10° C.] or less), and thereby the particles dispersed in the mixed dispersion liquid are caused to aggregate together to form aggregated particles.

In the aggregated particle formation step, alternatively, for example, the above coagulant may be added to the mixed dispersion liquid at room temperature (e.g., 25° C.) while the mixed dispersion liquid is stirred using a rotary-shearing homogenizer. Then, the pH of the mixed dispersion liquid is controlled to be acidic (e.g., pH of 2 or more and 5 or less), and a dispersion stabilizer may be added to the mixed dispersion liquid as needed. Subsequently, the mixed dispersion liquid is heated in the above-described manner.

Examples of the coagulant include surfactants, inorganic metal salts, and divalent or higher metal complexes that have a polarity opposite to that of the surfactant included in the mixed dispersion liquid. Using a metal complex as a coagulant reduces the amount of surfactant used and, as a result, charging characteristics may be enhanced.

An additive capable of forming a complex or a bond similar to a complex with the metal ions contained in the coagulant may optionally be used in combination with the coagulant. An example of the additive is a chelating agent.

Examples of the inorganic metal salts include metal salts, such as calcium chloride, calcium nitrate, barium chloride, magnesium chloride, zinc chloride, aluminum chloride, and aluminum sulfate; and inorganic metal salt polymers, such as polyaluminum chloride, polyaluminum hydroxide, and calcium polysulfide.

The chelating agent may be a water-soluble chelating agent. Examples of such a chelating agent include oxycarboxylic acids, such as tartaric acid, citric acid, and gluconic acid; and aminocarboxylic acids, such as iminodiacetic acid (IDA), nitrilotriacetic acid (NTA), and ethylenediaminetetraacetic acid (EDTA).

The amount of the chelating agent used is preferably 0.01 parts by mass or more and 5.0 parts by mass or less and is more preferably 0.1 parts by mass or more and less than 3.0 parts by mass relative to 100 parts by mass of the resin particles.

### Fusion Coalescence Step

The aggregated particle dispersion liquid in which the aggregated particles are dispersed is heated to, for example, a temperature equal to or higher than the glass transition temperature of the resin particles (e.g., [Glass transition temperature of the resin particles+10° C.] or more and [the Glass transition temperature+30° C.] or less) in order to perform fusion and coalescence of the aggregated particles and form toner particles.

The toner particles are produced through the above-described steps.

The toner particles may be produced by, subsequent to the preparation of the aggregated particle dispersion liquid in which the aggregated particles are dispersed, mixing the aggregated particle dispersion liquid with a resin particle dispersion liquid in which resin particles are dispersed and causing aggregation such that the resin particles are adhered onto the surfaces of the aggregated particles to form second aggregated particles; and heating a second aggregated particle dispersion liquid in which the second aggregated particles are dispersed to cause fusion and coalescence of the second aggregated particles and form toner particles having a core-shell structure.

After the completion of the fusion-coalescence step, the toner particles included in the dispersion liquid are subjected to any suitable cleaning step, solid-liquid separation step, and drying step that are known in the related art in order to obtain dried toner particles. In the cleaning step, the toner particles may be subjected to displacement washing using ion-exchange water to a sufficient degree from the viewpoint of electrification characteristics. Examples of a solid-liquid separation method used in the solid-liquid separation step include suction filtration and pressure filtration from the viewpoint of productivity. Examples of a drying method used in the drying step include freeze-drying, flash drying, fluidized drying, and vibrating fluidized drying from the viewpoint of productivity.

The fluorescent toner is produced by, for example, adding an external additive to the dried toner particles and mixing the resulting toner particles using a V-blender, a HENSCHEL mixer, a Lodige mixer, or the like. Optionally, coarse toner particles may be removed using a vibrating screen classifier, a wind screen classifier, or the like.

### Electrostatic Image Developer Set

An electrostatic image developer set according to an exemplary embodiment of the disclosure includes first to sixth electrostatic image developers each including a corresponding one of the cyan, magenta, yellow, and black toners and the fluorescent toners T_{A} and T_{B} included in the toner set according to an exemplary embodiment of the disclosure.

Each of the electrostatic image developers may be a single component developer including a toner or may be a two-component developer that is a mixture of a toner and a carrier.

The type of the carrier is not limited, and any suitable carrier known in the related art may be used. Examples of the carrier include a coated carrier prepared by coating the surfaces of cores including magnetic powder particles with a resin; a magnetic-powder-dispersed carrier prepared by dispersing and mixing magnetic powder particles in a matrix resin; and a resin-impregnated carrier prepared by impregnating a porous magnetic powder with a resin.

The magnetic-powder-dispersed carrier and the resin-impregnated carrier may also be prepared by coating the surfaces of particles constituting the carrier, that is, core particles, with a resin.

Examples of the magnetic powder include powders of magnetic metals, such as iron, nickel, and cobalt; and powders of magnetic oxides, such as ferrite and magnetite.

Examples of the coat resin and the matrix resin include polyethylene, polypropylene, polystyrene, poly (vinyl acetate), poly (vinyl alcohol), poly (vinyl butyral), poly (vinyl chloride), poly (vinyl ether), poly (vinyl ketone), a vinyl chloride-vinyl acetate copolymer, a styrene-acrylic acid ester copolymer, a straight silicone resin including an organosiloxane bond and the modified products thereof, a fluorine resin, polyester, polycarbonate, a phenolic resin, and an epoxy resin. The coat resin and the matrix resin may optionally include additives, such as conductive particles. Examples of the conductive particles include particles of metals, such as gold, silver, and copper; and particles of carbon black, titanium oxide, zinc oxide, tin oxide, barium sulfate, aluminum borate, and potassium titanate.

The surfaces of the cores can be coated with a resin by, for example, using a coating-layer forming solution prepared by dissolving the coat resin and various types of additives (used as needed) in a suitable solvent. The type of the solvent is not limited and may be selected with consideration of the type of the resin used, case of applying the coating-layer forming solution, and the like.

Specific examples of a method for coating the surfaces of the cores with the coat resin include an immersion method in which the cores are immersed in the coating-layer forming solution; a spray method in which the coating-layer forming solution is sprayed onto the surfaces of the cores; a fluidized-bed method in which the coating-layer forming solution is sprayed onto the surfaces of the cores while the cores are floated using flowing air; and a kneader-coater method in which the cores of the carrier are mixed with the coating-layer forming solution in a kneader coater and subsequently the solvent is removed.

The mixing ratio (i.e., mass ratio) of the toner to the carrier in the two-component developer is preferably Fluorescent toner: Carrier=1:100 to 30:100 and is more preferably 3:100 to 20:100.

### Image Forming Apparatus and Image Forming Method

An image forming apparatus and image forming method according to an exemplary embodiment of the disclosure are described below.

An image forming apparatus according to an exemplary embodiment of the disclosure includes first to sixth image formation units that form first to sixth images, respectively, which each use a corresponding one of the cyan, magenta, yellow, and black toners and the fluorescent toners T_{A} and T_{B} included in the toner set according to an exemplary embodiment of the disclosure, a transfer unit that transfers the first to sixth images to a recording medium, and a fixing unit that fixes the first to sixth images to the recording medium.

The image forming apparatus according to an exemplary embodiment of the disclosure may include first to six image formation units that each include an image holding member, a charging unit that charges the surface of the image holding member, an electrostatic image formation unit that forms an electrostatic image on the charged surface of the image holding member, and a developing unit that develops the electrostatic image formed on the surface of the image holding member with an electrostatic image developer to form a toner image.

Alternatively, the image forming apparatus according to an exemplary embodiment of the disclosure may include an image holding member, a charging unit that charges the surface of the image holding member, an electrostatic image formation unit that forms an electrostatic image on the charged surface of the image holding member, and first to six image formation units that include first to six developing units, respectively, which develop the electrostatic image formed on the surface of the image holding member with an electrostatic image developer to form a toner image.

The image forming apparatus according to an exemplary embodiment of the disclosure executes an image forming method (i.e., an image forming method according to an exemplary embodiment of the disclosure) including first to sixth image formation steps of forming first to sixth images, respectively, the first to sixth image formation steps each using a corresponding one of the cyan, magenta, yellow, and black toners and the fluorescent toners T_{A} and T_{B} included in the toner set according to an exemplary embodiment of the disclosure, a transfer step of transferring the first to six images to a recording medium, and a fixing step of fixing the first to six images to the recording medium.

The image forming apparatus according to an exemplary embodiment of the disclosure may be any image forming apparatus known in the related art, such as a direct-transfer image forming apparatus in which a toner image formed on the surface of an image holding member is directly transferred to a recording medium; an intermediate-transfer image forming apparatus in which a toner image formed on the surface of an image holding member is transferred onto the surface of an intermediate transfer body in the first transfer step and the toner image transferred on the surface of the intermediate transfer body is transferred onto the surface of a recording medium in the second transfer step; an image forming apparatus including a cleaning unit that cleans the surface of the image holding member subsequent to the transfer of the toner image before the image holding member is again charged; and an image forming apparatus including a static-erasing unit that erases static by irradiating the surface of an image holding member with static-erasing light subsequent to the transfer of the toner image before the image holding member is again charged.

In the case where the image forming apparatus according to this exemplary embodiment is the intermediate-transfer image forming apparatus, the transfer unit may be constituted by, for example, an intermediate transfer body to which a toner image is transferred, a first transfer subunit that transfers a toner image formed on the surface of the image holding member onto the surface of the intermediate transfer body in the first transfer step, and a second transfer subunit that transfers the toner image transferred on the surface of the intermediate transfer body onto the surface of a recording medium in the second transfer step.

An example of the image forming apparatus according to an exemplary embodiment of the disclosure is described below, but the image forming apparatus is not limited thereto. Hereinafter, only components illustrated in drawings are described; others are omitted.

A sextuple tandem image forming apparatus that includes six image forming units arranged in series is described below as an example of the image forming apparatus according to an exemplary embodiment of the disclosure.

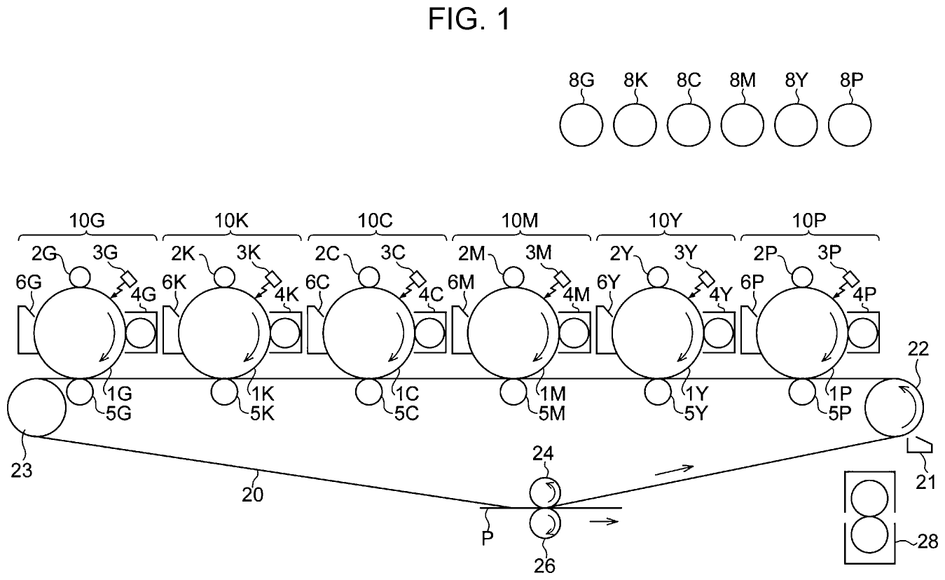

FIG. 1 schematically illustrates the image forming apparatus according to an exemplary embodiment of the disclosure. FIG. 1 illustrates a sextuple tandem, intermediate transfer-type image forming apparatus

The image forming apparatus illustrated in FIG. 1 includes first to sixth image formation units 10P, 10Y, 10M, 10C, 10K, and 10G, which are electrophotographic image forming units that form pink (P), yellow (Y), magenta (M), cyan (C), black (K), and green (G) images, respectively, on the basis of color separation image data. The image formation units (hereinafter, referred to simply as “units”) 10P, 10Y, 10M, 10C, 10K, and 10G are horizontally arranged in parallel at a predetermined distance from one another. The units 10P, 10Y, 10M, 10C, 10K, and 10G may be process cartridges detachably attachable to the image forming apparatus.

An intermediate transfer belt (an example of the intermediate transfer body) 20 runs below and extends over the units 10P, 10Y, 10M, 10C, 10K, and 10G so as to pass through the units. The intermediate transfer belt 20 is wound around a drive roller 22, a support roller 23, and a counter roller 24 arranged to contact with the inner surface of the intermediate transfer belt 20 and runs in the direction from the first unit 10P to the sixth unit 10G. An intermediate transfer body-cleaning device 21 is disposed so as to contact with the image holding member-side surface of the intermediate transfer belt 20 and to face the drive roller 22.

Developing devices (i.e., examples of developing units) 4P, 4Y, 4M, 4C, 4K, and 4G of the units 10P, 10Y, 10M, 10C, 10K, and 10G are supplied with pink, yellow, magenta, cyan, black, and green toners stored in toner cartridges 8P, 8Y, 8M, 8C, 8K, and 8G, respectively.

Note that, in the above step, the above-described fluorescent toner T_{A} is used as a green toner, and the above-described fluorescent toner T_{B} is used as a pink toner.

Since the first to sixth units 10P, 10Y, 10M, 10C, 10K, and 10G have the same structure and the same action, the following description is made with reference to, as a representative, the sixth unit 10G that forms a green image.

The sixth unit 10G includes a photosensitive member 1G serving as an image holding member. The following components are disposed around the photosensitive member 1G sequentially in the counterclockwise direction: a charging roller (example of the charging unit) 2G that charges the surface of the photosensitive member 1G at a predetermined potential; an exposure device (example of the electrostatic image formation unit) 3G that forms an electrostatic image by irradiating the charged surface of the photosensitive member 1G with a laser beam based on a color separated image signal; a developing device (example of the developing unit) 4G that develops the electrostatic image by supplying a toner to the electrostatic image; a first transfer roller (example of the first transfer subunit) 5G that transfers the developed toner image to the intermediate transfer belt 20; and a photosensitive-member cleaning device (example of the cleaning unit) 6G that removes a toner remaining on the surface of the photosensitive member 1G after the first transfer.

The first transfer roller 5G is disposed so as to contact with the inner surface of the intermediate transfer belt 20 and to face the photosensitive member 1G. Each of the first transfer rollers 5Y, 5P, 5M, 5C, 5G, and 5K of the respective units is connected to a bias power supply (not illustrated) that applies a first transfer bias to the first transfer rollers. Each bias power supply varies the transfer bias applied to the corresponding first transfer roller on the basis of the control by a controller (not illustrated).

The action of forming a green image in the sixth unit 10G is described below.

Before the action starts, the surface of the photosensitive member 1G is charged at a potential of −600 to −800 V by the charging roller 2G.

The photosensitive member 1G is formed by stacking a photosensitive layer on a conductive substrate (e.g., volume resistivity at 20° C.: 1×10⁻⁶ Ωcm or less). The photosensitive layer is normally of high resistance (comparable with the resistance of ordinary resins), but, upon being irradiated with the laser beam, the specific resistance of the portion irradiated with the laser beam varies. Thus, the exposure device 3G irradiates the surface of the charged photosensitive member 1G with the laser beam on the basis of the image data of the green image sent from the controller (not illustrated). As a result, an electrostatic image of green image pattern is formed on the surface of the photosensitive member 1G.

The term “electrostatic image” used herein refers to an image formed on the surface of the photosensitive member 1G by charging, the image being a “negative latent image” formed by irradiating a portion of the photosensitive layer with a laser beam emitted by the exposure device 3G to reduce the specific resistance of the irradiated portion such that the charges on the irradiated surface of the photosensitive member 1G discharge while the charges on the portion that is not irradiated with the laser beam remain.

The electrostatic image, which is formed on the photosensitive member 1G as described above, is sent to the predetermined developing position by the rotating photosensitive member 1G. The electrostatic image on the photosensitive member 1G is developed and visualized in the form of a toner image by the developing device 4G at the developing position.

The developing device 4G includes an electrostatic image developer including, for example, at least, a green toner and a carrier. The green toner is stirred in the developing device 4G to be charged by friction and supported on a developer roller (example of the developer support), carrying an electric charge of the same polarity (i.e., negative) as the electric charge generated on the photosensitive member 1G. The green toner is electrostatically adhered to the erased latent image portion on the surface of the photosensitive member 1G as the surface of the photosensitive member 1G passes through the developing device 4G. Thus, the latent image is developed using the green toner. The photosensitive member 1G on which the green toner image is formed keeps rotating at the predetermined rate, thereby transporting the toner image developed on the photosensitive member 1G to the predetermined first transfer position.

Upon the green toner image on the photosensitive member 1G reaching the first transfer position, first transfer bias is applied to the first transfer roller 5G so as to generate an electrostatic force on the toner image in the direction from the photosensitive member 1G toward the first transfer roller 5G. Thus, the toner image on the photosensitive member 1G is transferred to the intermediate transfer belt 20. The transfer bias applied has the opposite polarity (+) to that of the toner (−) and controlled to be, for example, in the sixth unit 10G, +10 μA by a controller (not illustrated).

After the toner image has been transferred from the photosensitive member 1G to the intermediate transfer belt 20, the photosensitive member 1G keeps rotating and is brought into contact with a cleaning blade included in the photosensitive member cleaning device 6G. The toner particles remaining on the photosensitive member 1G are removed by the photosensitive-member cleaning device 6G and then collected.

The intermediate transfer belt 20 is successively transported through the first to sixth image forming units 10P, 10Y, 10M, 10C, 10K, and 10G while toner images of the respective colors are stacked on top of another.

The resulting intermediate transfer belt 20 on which toner images of six colors are multiple-transferred in the first to sixth units is then transported to a second transfer section including a counter roller 24 contacting with the inner surface of the intermediate transfer belt 20 and a second transfer roller (example of the second transfer subunit) 26 disposed on the image-carrier-side of the intermediate transfer belt 20. A recording paper (example of the recording medium) P is fed by a feed mechanism into a narrow space between the second transfer roller 26 and the intermediate transfer belt 20 that contact with each other at the predetermined timing. The second transfer bias is then applied to the counter roller 24. The transfer bias applied here has the same polarity (−) as that of the toner (−) and generates an electrostatic force on the toner image in the direction from the intermediate transfer belt 20 toward the recording paper P. Thus, the toner image on the intermediate transfer belt 20 is transferred to the recording paper P. The intensity of the second transfer bias applied is determined on the basis of the resistance of the second transfer section which is detected by a resistance detector (not illustrated) that detects the resistance of the second transfer section and controlled by changing voltage.

After the toner image has been transferred from the intermediate transfer belt 20 to the recording paper P, the intermediate transfer belt 20 keeps running and is brought into contact with a cleaning blade included in the intermediate transfer body cleaning device 21. The toner particles remaining on the intermediate transfer belt 20 are removed by the intermediate transfer body cleaning device 21 and then collected.

The recording paper P on which the toner image is transferred is transported into a nip part of the fixing device (example of the fixing unit) 28 at which a pair of fixing rollers contact with each other. The toner image is fixed to the recording paper P to form a fixed image.

Examples of the recording paper P to which a toner image is transferred include plain paper used in electrophotographic copiers, printers, and the like. Instead of the recording paper P, OHP films and the like may be used as a recording medium.

The surface of the recording paper P may be smooth in order to enhance the smoothness of the surface of the fixed image. Examples of such a recording paper include coated paper produced by coating the surface of plain paper with resin or the like and art paper for printing.

The recording paper P, to which the color image has been fixed, is transported toward an exit portion. Thus, the series of the steps for forming a color image are terminated.

### Process Cartridge and Toner Cartridge Set

A process cartridge according to an exemplary embodiment of the disclosure is described below.

The process cartridge according to an exemplary embodiment of the disclosure is a process cartridge detachably attachable to an image forming apparatus, the process cartridge including first to sixth developing units each including a corresponding one of the first to sixth electrostatic image developers included in the electrostatic image developer set according to an exemplary embodiment of the disclosure.

The structure of the process cartridge according to an exemplary embodiment of the disclosure is not limited to the above-described one. The process cartridge may further include, in addition to the developing unit, at least one unit selected from an image holding member, a charging unit, an electrostatic image formation unit, a transfer unit, etc.

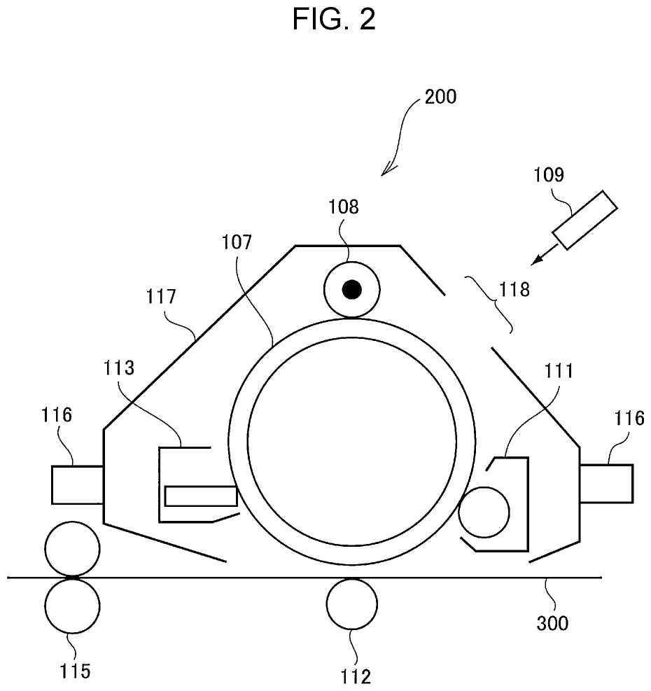

An example of the process cartridge according to an exemplary embodiment of the disclosure is described below, but the process cartridge is not limited thereto. Hereinafter, only components illustrated in FIG. 2 are described; others are omitted.

FIG. 2 schematically illustrates the process cartridge according to an exemplary embodiment of the disclosure.

A process cartridge 200 illustrated in FIG. 2 includes, for example, a photosensitive member 107 (example of the image holding member), a charging roller 108 (example of the charging unit) disposed on the periphery of the photosensitive member 107, a developing device 111 (example of the developing unit), and a photosensitive-member cleaning device 113 (example of the cleaning unit), which are combined into one unit using a housing 117 to form a cartridge. The housing 117 has an aperture 118 for exposure. A mounting rail 116 is disposed on the housing 117.

In FIG. 2, Reference numeral 109 denotes an exposure device (example of the electrostatic image formation unit), Reference numeral 112 denotes a transfer device (example of the transfer unit), Reference numeral 115 denotes a fixing device (example of the fixing unit), and the Reference numeral 300 denotes recording paper (example of the recording medium).

A toner cartridge set according to an exemplary embodiment of the disclosure is described below.

The toner cartridge set according to an exemplary embodiment of the disclosure is a toner cartridge set detachably attachable to an image forming apparatus, the toner cartridge set including first to sixth toner cartridges each including a corresponding one of the cyan toner, the magenta toner, the yellow toner, the black toner, the fluorescent toner T_{A}, and the fluorescent toner T_{B} included in the toner set according to an exemplary embodiment of the disclosure.

The toner cartridges each include a replenishment toner that is to be supplied to the developing unit disposed inside an image forming apparatus.

The image forming apparatus illustrated in FIG. 1 is an image forming apparatus that includes the toner cartridges 8Y, 8P, 8M, 8C, 8G, and 8K detachably attached to the image forming apparatus. Each of the developing devices 4Y, 4P, 4M, 4C, 4G, and 4K is connected to a specific one of the toner cartridges which corresponds to the color of the developing device with a toner supply pipe (not illustrated). When the amount of toner contained in a toner cartridge is small, the toner cartridge is replaced. The toner cartridge 8G is an example of the toner cartridge according to an exemplary embodiment of the disclosure and includes the toner set according to an exemplary embodiment of the disclosure. The toner cartridges 8P, 8Y, 8M, 8C, and 8K include pink, yellow, magenta, cyan, and black toners, respectively.

### Printed Material

A printed material according to an exemplary embodiment of the disclosure includes a recording medium and first to sixth images each including a corresponding one of the cyan toner, the magenta toner, the yellow toner, the black toner, the fluorescent toner T_{A}, and the fluorescent toner T_{B} included in the toner set according to an exemplary embodiment of the disclosure.

The printed material according to an exemplary embodiment of the disclosure is produced using the above-described image forming apparatus or method according to an exemplary embodiment of the disclosure.

The printed material according to an exemplary embodiment of the disclosure includes at least a recording medium and the first to sixth images formed on the surface of the recording medium and may further include an image formed using a toner having a color other than any of the colors of the first to sixth images.

As described above, the recording medium included in the printed material according to an exemplary embodiment of the disclosure may be a recording paper sheet P, an OHP film, or the like.

### EXAMPLES

Details of the exemplary embodiments of the present disclosure are described with reference to Examples below. It should be noted that the exemplary embodiments of the present disclosure are not limited by Examples.

Hereinafter, all “part” and “%” are on a mass basis unless otherwise specified.

Synthesis, treatment, production, and the like are conducted at room temperature (25° C.±3° C.) unless otherwise specified.

Preparation of Fluorescent Green Toner 1 and Developer Including Fluorescent Green Toner 1 Preparation of Coloring Agent Particle Dispersion Liquid (1)
Fluorescent pigment PY101 (C. I. Pigment Yellow 101 “Radglo VSF-0-01” produced by Radiant Color): 70 parts
Anionic surfactant “Neogen RK” produced by Dai-ichi Kogyo Seiyaku Co., Ltd.: 30 parts (solid component concentration: 20%)
Ion-exchange water: 200 parts

The above components are mixed together, and the resulting mixture is pulverized to 0.3 μm with Key Mill (continuous type) “KMC-3”. The solid content in the resulting dispersion liquid is adjusted to 20% by mass. Hereby, a coloring agent particle dispersion liquid (1) is prepared.

### Preparation of Coloring Agent Particle Dispersion Liquid (2)

Nonfluorescent Pigment PG36 (C. I. Pigment Green 36 “LIONOL GREEN 8624” produced by Toyocolor Co., Ltd.): 70 parts
Anionic surfactant “Neogen RK” produced by Dai-ichi Kogyo Seiyaku Co., Ltd.: 30 parts (solid component concentration: 20%)
Ion-exchange water: 200 parts

The above components are mixed together, and the resulting mixture is pulverized to 0.15 μm with Key Mill (continuous type) “KMC-3”. The solid content in the resulting dispersion liquid is adjusted to 20% by mass. Hereby, a coloring agent particle dispersion liquid (2) is prepared.

### Preparation of Resin Particle Dispersion Liquid (1)

Terephthalic acid: 30 molar parts
Fumaric acid: 70 molar parts
Bisphenol A-ethylene oxide adduct: 5 molar parts
Bisphenol A-propylene oxide adduct: 95 molar parts

The above materials are charged into a flask equipped with a stirrer, a nitrogen introduction tube, a temperature sensor, and a fractionating column. After the temperature of the resulting mixture has been increased to 220° C. over 1 hour, 1 part of titanium tetraethoxide relative to 100 parts of the materials is charged into the flask. While the product water is distilled away, the temperature is increased to 230° C. over 30 minutes. After the dehydration condensation reaction has been continued for 1 hour at the above temperature, the reaction product is cooled. Hereby, a polyester resin having a weight average molecular weight of 18,000 and a glass transition temperature of 60° C. is prepared.

Into a container equipped with a temperature control unit and a nitrogen purge unit, 40 parts of ethyl acetate and 25 parts of 2-butanol are charged in order to prepare a mixed solvent. To the mixed solvent, 100 parts of the polyester resin is gradually added in order to form a solution. To the solution, a 10-mass % aqueous ammonia solution is added in an amount that corresponds to three times the acid value of the resin in terms of molar ratio, and the resulting mixture is stirred for 30 minutes. Subsequently, the inside of the container is purged with dry nitrogen. While the temperature is kept at 40° C. and the liquid mixture is stirred, 400 parts of ion-exchange water is added dropwise to the container at a rate of 2 part/min. After the addition of ion-exchange water has been finished, the temperature is reduced to room temperature (20° C. to 25° C.). Subsequently, while stirring is performed, bubbling is performed for 48 hours using dry nitrogen in order to reduce the concentration of ethyl acetate and 2-butanol in the resulting resin particle dispersion liquid to 1,000 ppm or less. Then, ion-exchange water is added to the resin particle dispersion liquid in order to adjust the solid content in the resin particle dispersion liquid to 20% by mass. Hereby, a resin particle dispersion liquid (1) is prepared.

### Preparation of Release Agent Particle Dispersion Liquid (1)

Paraffin wax “HNP-9” produced by Nippon Seiro Co., Ltd.: 100 parts
Anionic surfactant “Neogen RK” produced by Dai-ichi Kogyo Seiyaku Co., Ltd.: 1 part
Ion-exchange water: 350 parts

The above materials are mixed together, and the resulting mixture is heated to 100° C. and dispersed with a homogenizer “ULTRA-TURRAX T50” produced by IKA. Subsequently, further dispersion treatment is performed with a Manton-Gaulin high pressure homogenizer produced by Gaulin. Hereby, a release agent particle dispersion liquid (1) (solid content: 20% by mass), in which release agent particles having a volume average size of 200 nm are dispersed, is prepared.

### Preparation of Toner Particles (1)

Resin particle dispersion liquid (1): 340 parts
Coloring agent particle dispersion liquid (1): 52 parts
Coloring agent particle dispersion liquid (2): 23 parts
Release agent particle dispersion liquid (1): 50 parts
Anionic surfactant “Neogen RK” Dai-ichi Kogyo Seiyaku Co., Ltd. (20%): 10 parts

The above materials are charged into a round-bottomed, stainless steel flask. After the pH has been adjusted to 3.5 by the addition of 0.1 N (mol/L) nitric acid, 30 parts of an aqueous nitric acid solution having a polyaluminum chloride concentration of 10% by mass is added to the flask. The resulting mixture is dispersed with a homogenizer “ULTRA-TURRAX T50” produced by IKA at a liquid temperature of 30° C. and subsequently heated to 45° C. in an oil bath for heating. Then, holding is performed for 30 minutes. Subsequently, 50 parts of the resin particle dispersion liquid (1) is added to the flask, and holding is performed for 1 hour. To the flask, a 0.1-N aqueous sodium hydroxide solution is added in order to adjust the pH to 8.5. Subsequently, the temperature is increased to 84° C. and holding is performed for 2.5 hours. Then, the temperature is reduced to 20° C. at 20° C./min, and the solid component is separated from the liquid by filtering, washed thoroughly with ion-exchange water, and dried. Hereby, toner particles (1) are prepared. The volume average size of the toner particles (1) is 5.8 μm.

### Preparation of Carrier 1

Ferrite particles (average size: 35 μm): 100 parts
Toluene: 14 parts
Polymethyl methacrylate (MMA, weight average molecular weight: 75,000): 5 parts
Carbon black “VXC-72” produced by Cabot Corporation (volume resistivity: 100 Ωcm or less): 0.2 parts

The above materials except the ferrite particles are dispersed with a sand mill to form a dispersion liquid. The dispersion liquid and the ferrite particles are charged into a degassing vacuum kneader. Then, while stirring is performed, the pressure is reduced and drying is performed. Hereby, a carrier 1 is prepared.

### Preparation of Toner

With 100 parts by mass of the toner particles (1), 1.5 parts by mass of hydrophobic silica “RY50” produced by Nippon Aerosil Co., Ltd. and 1.0 parts by mass of hydrophobic titanium oxide “T805” produced by Nippon Aerosil Co., Ltd. are mixed using a sample mill at 10,000 revolutions per minute (rpm) for 30 seconds. Subsequently, sieving is performed with a vibration sieve having an opening of 45 μm. Hereby, a fluorescent green toner 1 is prepared. The volume average particle size of the fluorescent green toner 1 is 5.8 μm.

### Preparation of Electrostatic Image Developer

A developer (electrostatic image developer) is prepared by mixing 8 parts of the fluorescent green toner 1 with 92 parts of the carrier 1 using a V-blender. Preparation of Fluorescent Green Toners 2 to 6 and Developers Including Fluorescent Green Toners 2 to 6

Toner particle samples are prepared as in the preparation of the toner particles (1), except that the type and amount of the coloring agent particle dispersion liquid used are changed as described in Table 1 below.

Furthermore, toners are prepared as in the preparation of the fluorescent green toner 1, except that the above toner particle samples are used instead, and developers are prepared using the above toners.

The coloring agent particle dispersion liquids (3) and (4) described in Table 1 are as follows.

### Preparation of Coloring Agent Particle Dispersion Liquid (3)

Nonfluorescent Pigment PG7 (C. I. Pigment Green 7 “LIONOL GREEN 8948” produced by Toyocolor Co., Ltd.): 70 parts
Anionic surfactant “Neogen RK” produced by Dai-ichi Kogyo Seiyaku Co., Ltd.: 30 parts (solid component concentration: 20%)
Ion-exchange water: 200 parts

The above components are mixed together, and the resulting mixture is pulverized to 0.16 μm with Key Mill (continuous type) “KMC-3”. The solid content in the resulting dispersion liquid is adjusted to 20% by mass. Hereby, a coloring agent particle dispersion liquid (3) is prepared.

### Preparation of Coloring Agent Particle Dispersion Liquid (4)

Nonfluorescent pigment PY74 (C.I. Pigment Yellow 74 “HANSA BRILLIANT YELLOW 5GX 03” produced by Clariant): 70 parts
Anionic surfactant “Neogen RK” produced by Dai-ichi Kogyo Seiyaku Co., Ltd.: 30 parts (solid component concentration: 20%)
Ion-exchange water: 200 parts

The above components are mixed together, and the resulting mixture is pulverized to 0.14 μm with Key Mill (continuous type) “KMC-3”. The solid content in the resulting dispersion liquid is adjusted to 20% by mass. Hereby, a coloring agent particle dispersion liquid (4) is prepared.

### Preparation of Fluorescent Pink Toner 1 and Developer Including Fluorescent Pink Toner 1 Preparation of Coloring Agent Particle Dispersion Liquid (5)

Fluorescent dye BR1: 1 (C. I. Basic Red 1:1 “Basonyl Red 485” produced by BASF SE: 2 parts
Amorphous polyester resin (weight average molecular weight: 13,000, glass transition temperature: 62° C.): 100 parts

The above materials are mixed together while heated in order to blend the dye into the resin. The resulting kneaded material is rolled and then cooled to 30° C. or less. Subsequently, the kneaded material is coarsely crushed to 1 mm or less with a hammer mill and then pulverized with a jet mill “AFG” produced by Hosokawa Micron Corporation. The pulverized particles are mixed with 30 parts of an anionic surfactant “Neogen RK” produced by Dai-ichi Kogyo Seiyaku Co., Ltd. (solid content: 20%) and 200 parts of ion-exchange water. The resulting mixture is pulverized to a volume average particle size of 200 nm with Key Mill (continuous type) “KMC-3” produced by Inoue Mfg., Inc. The solid content in the resulting dispersion liquid is adjusted to 20% by mass. Hereby, a coloring agent particle dispersion liquid (5) is prepared.

### Preparation of Coloring Agent Particle Dispersion Liquid (6)

Nonfluorescent pigment PR122 (C. I. Pigment Red 122 “FASTOGEN SUPER MAGENTAR” produced by DIC corporation): 70 parts
Anionic surfactant “Neogen RK” produced by Dai-ichi Kogyo Seiyaku Co., Ltd.: 30 parts
Ion-exchange water: 200 parts

The above materials are mixed together, and the resulting mixture is dispersed with a homogenizer “ULTRA-TURRAX T50” produced by IKA for 10 minutes. The solid content in the resulting dispersion liquid is adjusted to 20% by mass by addition of ion-exchange water. Hereby, a coloring agent particle dispersion liquid (6) in which coloring agent particles having a volume average size of 140 nm are dispersed is prepared.

### Preparation of Toner Particles (2)

Resin particle dispersion liquid (1): 170 parts
Coloring agent particle dispersion liquid (5): 170 parts
Coloring agent particle dispersion liquid (6): 2 parts
Release agent particle dispersion liquid (1): 50 parts
Anionic surfactant “Neogen RK” Dai-ichi Kogyo Seiyaku Co., Ltd. (20%): 10 parts

The above materials are charged into a round-bottomed, stainless steel flask. After the pH has been adjusted to 3.5 by the addition of 0.1 N (mol/L) nitric acid, 30 parts of an aqueous nitric acid solution having a polyaluminum chloride concentration of 10% by mass is added to the flask. The resulting mixture is dispersed with a homogenizer “ULTRA-TURRAX T50” produced by IKA at a liquid temperature of 30° C. and subsequently heated to 45° C. in an oil bath for heating. Then, holding is performed for 30 minutes. Subsequently, 50 parts of the resin particle dispersion liquid (1) is added to the flask, and holding is performed for 1 hour. To the flask, a 0.1-N aqueous sodium hydroxide solution is added in order to adjust the pH to 8.5. Subsequently, the temperature is increased to 84° C. and holding is performed for 2.5 hours. Then, the temperature is reduced to 20° C. at 20° C./min, and the solid component is separated from the liquid by filtering, washed thoroughly with ion-exchange water, and dried. Hereby, toner particles (2) are prepared. The volume average size of the toner particles (2) is 5.7 μm.

### Preparation of Toner and Developer

A fluorescent pink toner 1 is prepared as in the preparation of the fluorescent green toner 1, except that the toner particles (2) are used instead, and a developer is prepared using the fluorescent pink toner 1.

### Preparation of Fluorescent Pink Toners 2 to 6 and Developers Including Fluorescent Pink Toners 2 to 6

Toner particle samples are prepared as in the preparation of the toner particles (2), except that the type and amount of the coloring agent particle dispersion liquid used are changed as described in Table 1 below.

Furthermore, toners are prepared as in the preparation of the fluorescent pink toner 1, except that the above toner particle samples are used instead, and developers are prepared using the above toners.

The coloring agent particle dispersion liquids (7) and (8) described in Table 1 are as follows.

### Preparation of Coloring Agent Particle Dispersion Liquid (7)

Fluorescent dye BV11: 1 (C. I. Basic Violet 11:1 “Basonyl Red 560” produced by BASF SE: 2 parts
Amorphous polyester resin (weight average molecular weight: 13,000, glass transition temperature: 62° C.): 100 parts

The above materials are mixed together while heated in order to blend the dye into the resin. The resulting kneaded material is rolled and then cooled to 30° C. or less. Subsequently, the kneaded material is coarsely crushed to 1 mm or less with a hammer mill and then pulverized with a jet mill “AFG” produced by Hosokawa Micron Corporation. The pulverized particles are mixed with 30 parts of an anionic surfactant “Neogen RK” produced by Dai-ichi Kogyo Seiyaku Co., Ltd. (solid content: 20%) and 200 parts of ion-exchange water. The resulting mixture is pulverized to a volume average particle size of 200 nm with Key Mill (continuous type) “KMC-3” produced by Inoue Mfg., Inc. The solid content in the resulting dispersion liquid is adjusted to 20% by mass. Hereby, a coloring agent particle dispersion liquid (7) is prepared.

### Preparation of Coloring Agent Particle Dispersion Liquid (8)

Nonfluorescent pigment PR185 (C. I. Pigment Red 185 “NOVOPERM CARMINE HF4C” produced by Clariant): 70 parts
Nonfluorescent pigment PR122 (C. I. Pigment Red 122 “FASTOGEN SUPER MAGENTAR” produced by DIC corporation): 70 parts
Anionic surfactant “Neogen RK” produced by Dai-ichi Kogyo Seiyaku Co., Ltd.: 30 parts
Ion-exchange water: 200 parts

The above materials are mixed together, and the resulting mixture is dispersed with a homogenizer “ULTRA-TURRAX T50” produced by IKA for 10 minutes. The solid content in the resulting dispersion liquid is adjusted to 20% by mass by addition of ion-exchange water. Hereby, a coloring agent particle dispersion liquid (8) in which coloring agent particles having a volume average size of 140 nm are dispersed is prepared.

### Examples 1 to 10 and Comparative Examples 1 and 2

Toner sets are prepared by combining the toners and developers prepared as described above with one another as described in Table 1.

Note that the cyan, magenta, yellow, and black toners used are commercial cyan, magenta, yellow, and black toners.

### Evaluations

### Graininess Evaluation

A 5 cm×5 cm patch halftone image is formed at L*=90 (ultra-highlighted region) or L*=80 (highlighted region) by changing the area fraction of an image including a fluorescent pink toner and a fluorescent green toner that overlap each other in order to prepare an evaluation image. The halftone image is evaluated in terms of graininess on the basis of color noise.

In this evaluation, color noise is used as an index of graininess. A color image is taken with a scanner and converted into a scanner RGB signal, which is decomposed into lightness, chroma, and hue of uniform color space (CIELAB). Subsequently, the two-dimensional color space is converted into a two-dimensional frequency space. The two-dimensional frequency space is multiplied by a visual transfer function (VTF). The amplitude of the two-dimensional frequency space processed by VTF is contour-integrated for each frequency in order to calculate a color noise vector. A color noise value (CN value) is calculated using a subjective prediction model on the basis of the color noise vector. In the evaluation, the larger the color noise value, the greater the noise and the lower the evaluation grade in terms of graininess.

Evaluation Standard
AA: The CN index is 1.2 or less.
A: The CN index is more than 1.2 and 2.0 or less.
B: The CN index is more than 2.0 and 2.5 or less.
C: The CN index is more than 2.5 and 3.0 or less.
D: The CN index is more than 3.0.

### Gray Tone

A 5 cm×5 cm patch halftone image is formed at L*=90 (ultra-highlighted region) or L*=80 (highlighted region) by changing the area fraction of an image including a fluorescent pink toner and a fluorescent green toner that overlap each other in order to prepare an evaluation image. The halftone image is evaluated in terms of gray tone.

Specifically, the chroma (C*) of the halftone image is calculated by the above-described method and evaluated in accordance with the standard below.

Evaluation Standard
AA: The degree of chroma is 2 or less.
A: The degree of chroma is more than 2 and 3 or less.
B: The degree of chroma is more than 3 and 4 or less.
C: The degree of chroma is more than 4.

TABLE 1

| | | | | | | Hue | | | | Graininess | |
|---|---|---|---|---|---|---|---|---|---|---|---|
| | | (Coloring agent particle | Hue | | | angle | Chroma | Lightness | Emission | (Ultrahigh- | |
| | | dispersion liquid No.) | angle | | | difference | differ- | differ- | intensity | lighted, | Gray |
| | Toner No. | Coloring agent | [deg] | Chroma | Lightness | [deg] | ence | ence | [%] | L* = 90) | tone |
| Example 1 | Fluorescent | (5)BR1:1 + (6)PR122 | 0 | 72 | 65 | 135 | 29 | 19 | 11 | B | B |
| | pink toner 1 | | | | | | | | | | |
| | Fluorescent | (1)PY101 + (2)PG36 | 135 | 101 | 84 | | | | 15 | | |
| | green toner 1 | | | | | | | | | | |
| Example 2 | Fluorescent | (5)BR1:1 + (6)PR122 + | −10 | 72 | 62 | 150 | 28 | 19 | 12 | B | A |
| | pink toner 2 | (7)BV11:1 | | | | | | | | | |
| | Fluorescent | (1)PY101 + (2)PG36 | 140 | 100 | 81 | | | | 13 | | |
| | green toner 2 | | | | | | | | | | |
| Example 3 | Fluorescent | (6)PR122 + (7)BV11:1 | −25 | 75 | 59 | 180 | 28 | 18 | 11 | AA | AA |
| | pink toner 3 | | | | | | | | | | |
| | Fluorescent | (1)PY101 + (3)PG7 | 155 | 103 | 77 | | | | 9 | | |
| | green toner 3 | | | | | | | | | | |
| Example 4 | Fluorescent | (5)BR1:1 + (6)PR122 | 0 | 83 | 65 | 135 | 18 | 19 | 8 | A | B |
| | pink toner 4 | | | | | | | | | | |
| | Fluorescent | (1)PY101 + (2)PG36 | 135 | 101 | 84 | | | | 15 | | |
| | green toner 1 | | | | | | | | | | |
| Example 5 | Fluorescent | (5)BR1:1 + (6)PR122 | 0 | 83 | 65 | 135 | 28 | 9 | 8 | A | B |
| | pink toner 4 | | | | | | | | | | |
| | Fluorescent | (1)PY101 + (2)PG36 | 135 | 111 | 74 | | | | 11 | | |
| | green toner 4 | | | | | | | | | | |
| Example 6 | Fluorescent | (5)BR1:1 + (7)BV11:1 | −10 | 81 | 73 | 150 | 19 | 8 | 16 | A | A |
| | pink toner 5 | | | | | | | | | | |
| | Fluorescent | (1)PY101 + (2)PG36 | 140 | 100 | 81 | | | | 13 | | |
| | green toner 2 | | | | | | | | | | |
| Example 7 | Fluorescent | (5)BR1:1 + (6)PR122 | 0 | 67 | 66 | 135 | 34 | 18 | 15 | C | B |
| | pink toner 6 | | | | | | | | | | |
| | Fluorescent | (1)PY101 + (2)PG36 | 135 | 101 | 84 | | | | 15 | | |
| | green toner 1 | | | | | | | | | | |
| Example 8 | Fluorescent | (5)BR1:1 + (8)PR185 | 0 | 72 | 60 | 135 | 29 | 24 | 9 | C | B |
| | pink toner 7 | | | | | | | | | | |
| | Fluorescent | (1)PY101 + (2)PG36 | 135 | 101 | 84 | | | | 15 | | |
| | green toner 1 | | | | | | | | | | |
| Example 10 | Fluorescent | (5)BR1:1 + (8)PR185 | 0 | 68 | 59 | 135 | 28 | 19 | 4 | C | B |
| | pink toner 8 | | | | | | | | | | |
| | Fluorescent | (1)PY101 + (2)PG36 + | 135 | 96 | 78 | | | | 4 | | |
| | green toner 5 | (4)PY74 | | | | | | | | | |
| Comparative | Pink toner | (8)PR185 | 0 | 54 | 51 | 135 | 32 | 21 | 0 | D | B |
| Example 1 | Green toner | (2)PG36 + (4)PY74 | 135 | 86 | 72 | | | | 0 | | |
| Comparative | Fluorescent | (5)BR1:1 + (6)PR122 | 0 | 72 | 65 | 130 | 31 | 22 | 11 | B | C |
| Example 2 | pink toner 1 | | | | | | | | | | |
| | Fluorescent | (1)PY101 + (2)PG36 | 130 | 103 | 87 | | | | 17 | | |
| | green toner 6 | | | | | | | | | | |

The results described in Table 1 confirm that images excellent in terms of graininess and gray tone may be formed using the toner sets prepared in Examples.

### Image Formation Using Actual Machine

An electrophotographic, intermediate transfer-type, sextuple tandem image forming apparatus is prepared. A pink developer (i.e., the developer including the fluorescent pink toner 1 used in Example 1), a yellow developer, a magenta developer, a cyan developer, a black developer, and a green developer (i.e., the fluorescent green developer, that is, the developer including the fluorescent green toner 1 used in Example 1) are each charged into a corresponding one of the six developing units. An image is formed on an A4-size coated paper sheet on the basis of image data prepared by separating RGB data into the above six colors. An image having suitable color reproducibility, which is close to the original RGB data, is formed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))) A toner set including:
a cyan toner;
a magenta toner;
a yellow toner;
a black toner;
a fluorescent toner T_{A} having a hue angle of 125 degrees or more and 165 degrees or less; and
a fluorescent toner T_{B} having a hue angle of −25 degrees or more and 15 degrees or less,
wherein a difference between the hue angles of the fluorescent toners T_{A} and T_{B} is 135 degrees or more.
(((2))) The toner set according to (((1))),
wherein the difference between the hue angles of the fluorescent toners T_{A} and T_{B} is 145 degrees or more and 180 degrees or less.
(((3))) The toner set according to (((2))),
wherein the difference between the hue angles of the fluorescent toners T_{A} and T_{B} is 160 degrees or more and 180 degrees or less.
(((4))) The toner set according to (((1))),
wherein a difference between degrees of chroma of the fluorescent toners T_{A} and T_{B} is 30 or less.
(((5))) The toner set according to (((1))),
wherein a difference between degrees of lightness of the fluorescent toners T_{A} and T_{B} is 20 or less.
(((6))) The toner set according to (((1))),
wherein a difference between degrees of chroma of the fluorescent toners T_{A} and T_{B} is 30 or less, and
a difference between degrees of lightness of the fluorescent toners T_{A} and T_{B} is 20 or less.
(((7))) The toner set according to (((1))),
wherein a difference between the hue angles of the fluorescent toners T_{A} and T_{B} is 145 degrees or more and 180 degrees or less,
a difference between degrees of chroma of the fluorescent toners T_{A} and T_{B} is 30 or less, and
a difference between degrees of lightness of the fluorescent toners T_{A} and T_{B} is 20 or less.
(((8))) The toner set according to (((1))),
wherein the fluorescent toners T_{A} and T_{B} have a fluorescence intensity of 5% or more.
(((9))) An electrostatic image developer set including:
first to sixth electrostatic image developers each including a corresponding one of the cyan toner, the magenta toner, the yellow toner, the black toner, the fluorescent toner T_{A}, and the fluorescent toner T_{B} included in the toner set according to any one of (((1))) to (((8))).
(((10))) A toner cartridge set detachably attachable to an image forming apparatus, the toner cartridge set including:
first to sixth toner cartridges each including a corresponding one of the cyan toner, the magenta toner, the yellow toner, the black toner, the fluorescent toner T_{A}, and the fluorescent toner T_{B} included in the toner set according to any one of (((1))) to (((8))).
(((11))) A process cartridge detachably attachable to an image forming apparatus, the process cartridge including:
first to sixth developing units each including a corresponding one of the first to sixth electrostatic image developers included in the electrostatic image developer set according to (((9))).
(((12))) An image forming apparatus including:
first to sixth image formation units that form first to sixth images, respectively, the first to sixth image formation units each using a corresponding one of the cyan toner, the magenta toner, the yellow toner, the black toner, the fluorescent toner T_{A}, and the fluorescent toner T_{B} included in the toner set according to any one of (((1))) to (((8)));
a transfer unit that transfers the first to sixth images to a recording medium; and
a fixing unit that fixes the first to sixth images to the recording medium.
(((13))) An image forming method including:
first to sixth image formation steps of forming first to sixth images, respectively, the first to sixth image formation steps each using a corresponding one of the cyan toner, the magenta toner, the yellow toner, the black toner, the fluorescent toner T_{A}, and the fluorescent toner T_{B} included in the toner set according to any one of (((1))) to (((8)));
a transfer step of transferring the first to sixth images to a recording medium; and
a fixing step of fixing the first to sixth images to the recording medium.
(((14))) A printed material including:
a recording medium; and
first to sixth images each including a corresponding one of the cyan toner, the magenta toner, the yellow toner, the black toner, the fluorescent toner T_{A}, and the fluorescent toner T_{B} included in the toner set according to any one of (((1))) to (((8))).

What is claimed is:

1. A toner set comprising:
a cyan toner;
a magenta toner;
a yellow toner;
a black toner;
a fluorescent toner T_{A} having a hue angle of 125 degrees or more and 165 degrees or less; and
a fluorescent toner T_{B} having a hue angle of −25 degrees or more and 15 degrees or less,
wherein a difference between the hue angles of the fluorescent toners T_{A} and T_{B} is 135 degrees or more.

2. The toner set according to claim 1,
wherein the difference between the hue angles of the fluorescent toners T_{A} and T_{B} is 145 degrees or more and 180 degrees or less.

3. The toner set according to claim 2,
wherein the difference between the hue angles of the fluorescent toners T_{A} and T_{B} is 160 degrees or more and 180 degrees or less.

4. The toner set according to claim 1,
wherein a difference between degrees of chroma of the fluorescent toners T_{A} and T_{B} is 30 or less.

5. The toner set according to claim 1,
wherein a difference between degrees of lightness of the fluorescent toners T_{A} and T_{B} is 20 or less.

6. The toner set according to claim 1,
wherein a difference between degrees of chroma of the fluorescent toners T_{A} and T_{B} is 30 or less, and
a difference between degrees of lightness of the fluorescent toners T_{A} and T_{B} is 20 or less.

7. The toner set according to claim 1,
wherein a difference between the hue angles of the fluorescent toners T_{A} and T_{B} is 145 degrees or more and 180 degrees or less,
a difference between degrees of chroma of the fluorescent toners T_{A} and T_{B} is 30 or less, and
a difference between degrees of lightness of the fluorescent toners T_{A} and T_{B} is 20 or less.

8. The toner set according to claim 1,
wherein the fluorescent toners T_{A} and T_{B} have a fluorescence intensity of 5% or more.

9. An electrostatic image developer set comprising:
first to sixth electrostatic image developers each including a corresponding one of the cyan toner, the magenta toner, the yellow toner, the black toner, the fluorescent toner T_{A}, and the fluorescent toner T_{B} included in the toner set according to claim 1.

10. An electrostatic image developer set comprising:
first to sixth electrostatic image developers each including a corresponding one of the cyan toner, the magenta toner, the yellow toner, the black toner, the fluorescent toner T_{A}, and the fluorescent toner T_{B} included in the toner set according to claim 2.

11. An electrostatic image developer set comprising:
first to sixth electrostatic image developers each including a corresponding one of the cyan toner, the magenta toner, the yellow toner, the black toner, the fluorescent toner T_{A}, and the fluorescent toner T_{B} included in the toner set according to claim 3.

12. An electrostatic image developer set comprising:
first to sixth electrostatic image developers each including a corresponding one of the cyan toner, the magenta toner, the yellow toner, the black toner, the fluorescent toner T_{A}, and the fluorescent toner T_{B} included in the toner set according to claim 4.

13. An electrostatic image developer set comprising:
first to sixth electrostatic image developers each including a corresponding one of the cyan toner, the magenta toner, the yellow toner, the black toner, the fluorescent toner T_{A}, and the fluorescent toner T_{B} included in the toner set according to claim 5.

14. An electrostatic image developer set comprising:
first to sixth electrostatic image developers each including a corresponding one of the cyan toner, the magenta toner, the yellow toner, the black toner, the fluorescent toner T_{A}, and the fluorescent toner T_{B} included in the toner set according to claim 6.

15. A toner cartridge set detachably attachable to an image forming apparatus, the toner cartridge set comprising:
first to sixth toner cartridges each including a corresponding one of the cyan toner, the magenta toner, the yellow toner, the black toner, the fluorescent toner T_{A}, and the fluorescent toner T_{B} included in the toner set according to claim 1.

16. A toner cartridge set detachably attachable to an image forming apparatus, the toner cartridge set comprising:
first to sixth toner cartridges each including a corresponding one of the cyan toner, the magenta toner, the yellow toner, the black toner, the fluorescent toner T_{A}, and the fluorescent toner T_{B} included in the toner set according to claim 2.

17. A process cartridge detachably attachable to an image forming apparatus, the process cartridge comprising:
first to sixth developing units each including a corresponding one of the first to sixth electrostatic image developers included in the electrostatic image developer set according to claim 9.

18. An image forming apparatus comprising:
first to sixth image formation units that form first to sixth images, respectively, the first to sixth image formation units each using a corresponding one of the cyan toner, the magenta toner, the yellow toner, the black toner, the fluorescent toner T_{A}, and the fluorescent toner T_{B} included in the toner set according to claim 1;
a transfer unit that transfers the first to sixth images to a recording medium; and
a fixing unit that fixes the first to sixth images to the recording medium.

19. An image forming method comprising:
first to sixth image formation steps of forming first to sixth images, respectively, the first to sixth image formation steps each using a corresponding one of the cyan toner, the magenta toner, the yellow toner, the black toner, the fluorescent toner T_{A}, and the fluorescent toner T_{B} included in the toner set according to claim 1;
a transfer step of transferring the first to sixth images to a recording medium; and
a fixing step of fixing the first to sixth images to the recording medium.

20. A printed material comprising:
a recording medium; and
first to sixth images each including a corresponding one of the cyan toner, the magenta toner, the yellow toner, the black toner, the fluorescent toner T_{A}, and the fluorescent toner T_{B} included in the toner set according to claim 1.
